(19) United States
(12) Patent Application Publication
(10) Pub. No.: US 2025/0363529 A1
(43) Pub. Date: Nov. 27, 2025

(54) Competitive Contribution Incented Transaction Prediction

(71) Applicant: EDATANETWORKS INC, Edmonton (CA)

(72) Inventors: Terrance Patrick Tietzen, Edmonton (CA); Matthew Arnold Macpherson BATES, Beaumont (CA)

(73) Assignee: EDATANETWORKS INC, Edmonton (CA)

(21) Appl. No.: 19/066,058

(22) Filed: Feb. 27, 2025

Related U.S. Application Data
(60) Provisional application No. 63/651,495, filed on May 24, 2024.
(60) Provisional application No. 63/705,131, filed on Oct. 9, 2024.

(51) Int. Cl. G06Q 30/0279; G06Q 20/40

(52) U.S. Cl. CPC G06Q 30/0279; G06Q 20/405; G06Q 20/401

(57) ABSTRACT

A merchant incentivizes an account holder to make an authorized transaction by terms and agreement to auditably contribute to the account holder's affinity entity. To incent desirable commerce with locals, the merchant's terms may limit its contribution by a derivation of navigation time between account holder and merchant, and/or by date and time of the transaction. The account holder can direct the contribution to one of more affinity entities within their own community, and/or within a community where the transaction was physically conducted. All such contributions will be bifurcated into at least two (2) parts: (i) a fund to which the account holder's affinity entity has ready access; and (ii) an endowment trust for the benefit of the account holder's affinity entity to which the account holder's affinity entity has limited access, such as to a portion of income from investment of the principal in the endowment trust with the remainder of the income being added to the principal in the endowment trust for investment of the principal. A vertical AI agent can also incentive such transactions by predicting, for a competition between two or more competitor groups of debit/credit account holders, which competition is to take place in a geotargeted area during a specific calendar period, which competition has a probability exceeding a first predetermined threshold to raise funds contributed to account holder selected affinity entities, which contributed funds exceed a second predetermined threshold. The vertical AI agent predicts those competitor groups that are most likely, by the first predetermined threshold, to raise statistically significant contributions, by the second predetermined threshold, from merchant defined contributions to account holder selected charities

### CROSS REFERENCE TO RELATED APPLICATIONS

This utility patent application claims priority to U.S. Provisional Application Ser. No. 63/651,495, filed May 24, 2024, titled “Consumer Transaction Incented By Donor-Merchant Obligatory Dual Consumer-Selected Donee Ready Access Fund Contribution and Consumer-Selected Donee Endowment Trust Donation,” and to U.S. Provisional Application Ser. No. 63/705, 131, filed Oct. 9, 2024, titled “Consumer Transaction Incented By Challenger Matched Donor-Merchant Obligatory Dual Consumer-Selected Donee Ready Access Fund Donation and Consumer-Selected Donee Endowment Trust Contribution,” each of which is incorporated herein by reference.

This application hereby incorporates by reference: US Patent Application Publication No. 2017/0278125, entitled “LOYALTY PROGRAM INCENTING MERCHANT TRANSACTION WITH CUSTOMER AFFINITY”, published on Sep. 28, 2017, filed on Feb. 20, 2017; U.S. Pat. No. 10,846,731, entitled “SYSTEM FOR CHANGING OPERATION MODES IN A LOYALTY PROGRAM”, filed Oct. 9, 2015; U.S. Provisional Patent Application 62/061,829, entitled “SYSTEMS AND METHODS FOR LOYALTY PROGRAMS”, filed Oct. 9, 2014; U.S. Provisional Patent Application 62/111,445, entitled “SYSTEMS AND METHODS FOR LOYALTY PROGRAMS”, filed Feb. 10, 2015; and U.S. Provisional Patent Application 62/172,446, entitled “SYSTEMS AND METHODS FOR LOYALTY PROGRAMS”, filed Jun. 8, 2015; U.S. Provisional Application No. 62/093,812, filed Dec. 18, 2014, and entitled “Devices, Systems And Methods For Feedback”; U.S. Utility patent application Ser. No. 14/973,918, filed Dec. 18, 2015, entitled “Devices, systems and methods for managing feedback in a network of computing resources”; U.S. Pat. No. 10,108,610, filed Jan. 31, 2013, entitled “Automated cause management”; and Patent Cooperation Treaty Application Serial No. PCT/US2013/032175 published on Nov. 9, 2013 as WIPO (PCT) WO2013138739A1, titled “Proximal customer transaction incented by contribution of auto-boarded merchant”.

### FIELD

Implementations generally relate to incentives by merchants to encourage purchases by consumers who are most likely to make purchases, more particularly relates to merchants incenting consumers to make purchases by the merchants agreement to make contributions to consumer selected affinity entities, and most particularly relates to a competition between two or more competitor groups of account holders, which competition is to take place in a geotargeted area during a specific calendar period, which competition has a probability exceeding a first predetermined threshold to raise funds contributed to account holder selected affinity entities, which contributed funds exceed a second predetermined threshold, which contributed funds are directed to affinity groups (e.g. charities) selected by the account holders, which contributed funds result from account holder transactions with merchants, and which transactions are incented by merchant agreements to make defined contributions to the geotargeted, account holder selected affinity entities.

### BACKGROUND

Merchants often use techniques to prompt consumers into making a particular purchase. These techniques are commonly in the form of monetary incentives, relying on the principle that a lower price will result in increased sales. Merchants may employ these techniques, for example, to help clear inventory before a new season's merchandise is released, to ease the release of a new product, to increase sales near the end of the fiscal year, to compete with a competitor over particular products, or to generally spur sales. Monetary incentives may come in the form of a “sale” (i.e., temporary reduction in price at the register), a discount coupon, a mail-in rebate (i.e., a refund of part or the entire purchase price by mail), or a store credit (i.e., credit that can be applied to another store purchase). These incentives usually only apply to a particular product and have a time component. For example, a sale may only apply to a particular brand of dishwasher purchased on a particular holiday weekend and a rebate may only be valid for computers purchased within two weeks before the start of classes at a university.

Although consumers are typically incented to make purchases by a form of price reduction, non-monetary reasons also motivate consumers to make purchases with a merchant, for instance where the consumers believes that the merchant is a force for good and thus the consumers are non-monetarily incented to do business with the merchant who they deem worthy of such support. As such, it would be an advance in the art to provide a non-monetary incentive motivate a consumer to conduct a transaction with a merchant.

Studies show that a significant portion of spending by a consumer is geographically restricted to a region that is proximal to where a consumer resides. Yet another problem for merchants, especially small to mid-sized merchants, are inefficiencies in attracting consumers to their brick and mortar stores which are within the geographically close region to where those consumers reside. A still further advance in the art of commerce would be to provide a system that provides incentives to consumers who are likely to shop at brick and mortar stores within a geographically region that is close to where those consumers reside.

A traditional means of raising money for local community charities in the United States has been through the United Way organization, a well-known international nonprofit organization that focuses on improving lives by mobilizing communities to address local issues. There are various Untied Way organization, each which typically has a Community-Based Focus. United Way organizations operate at the local level, addressing the specific needs of their communities. They work to identify and solve pressing problems related to education, financial stability, and health. United Way is known for its fundraising efforts, often through workplace campaigns and payroll deductions. They then allocate these funds to various local nonprofit programs and initiatives. A key aspect of United Way's work is bringing together diverse stakeholders, including volunteers, donors, partner agencies, and community leaders. This collaborative approach aims to create lasting, systemic changes. While local United Ways address unique community needs, their work often centers on: (i) Education: Helping children and youth succeed; (ii) Supporting families in achieving financial security; and (iii) Ensuring access to quality healthcare.

Over the past few decades, however, United Way has experienced a notable decline in contributions. The rise of specialized charities has had an effect in that donors increasingly prefer to support specific causes or organizations with direct, visible impact. This contrasts with United Way's historical model of broad-based, community-wide funding. Another factor has been the growth of online giving platforms like GoFundMe, Kickstarter, and others which provide donors with direct access to individuals and causes, bypassing traditional intermediaries. Another factor has been increased donor scrutiny. Donors are more demanding of transparency and accountability, seeking clear evidence of how their contributions are utilized. Yet another factor has been changes in workplace giving, including the decline of traditional employment. The shift from large, centralized workplaces to more dispersed, contract-based, and remote work environments has reduced the effectiveness of United Way's traditional workplace giving campaigns. As a consequence there has been reduced employee participation in United Way fund raising campaigns. Younger generations may be less inclined to participate in payroll deduction programs, preferring more direct and personalized giving.

Other reasons for the decline in contributions from United Way campaigns include corporate restructuring from mergers, acquisitions, and downsizing, concerns about administrative costs, lack of perceived impact by some donors who may feel that United Way's broad approach lacks the tangible impact of more focused charities, economic factors such as economic downturns, recessions, and economic instability which can lead to decreased disposable income and reduced charitable giving.

Given the above and other numerous problems imposed upon available sales and marketing resources available to small and medium sized business merchants in designing, implementing, and maintaining consumer incentive programs, as well as with the problems with traditions charitable fund raising efforts, such as Untied Way, it would be an advance in the relevant arts to provide systems to revitalize fundraising efforts while affirming community support by using automatic data analysis, natural language processing, and predictive analytics to predict, and then implement, successful fund raising competitions among competitors each composed of account holders conducting transactions incented by merchants who agree to make defined contributions to affinity entities selected by the account holders, where the sum of total contributions from each competitor groups' transitions constitutes raise funds used to determine which competitor group has won the competition.

### SUMMARY

A vertical AI agent operates on myriad databases to predict, for a competition between two or more competitor groups of debit/credit account holders, which competition is to take place in a geotargeted area during a specific calendar period, which competition has a probability exceeding a first predetermined threshold to raise funds contributed to account holder selected affinity entities, which contributed funds exceed a second predetermined threshold, which contributed funds are directed to affinity groups (e.g. charities) selected by the account holders, which contributed funds result from account holder transactions with merchants, and which transactions are incented by merchant agreements to make defined contributions to the geotargeted, account holder selected affinity entities. Using automatic data analysis, natural language processing, and predictive analytics, the vertical AI agent identifies patterns in the myriad databases, to predict those competitor groups that are most likely (the first predetermined threshold) to raise statistically significant contributions (the second predetermined threshold) from merchant defined contributions to account holder selected charities.

In addition to the foregoing, one or more implementations, which may be used in conjunction with the foregoing, relate to computer-implemented methods and server-implemented methods where, for each transaction between an account holder and a merchant, information is received that is derived from an authorization response for the transaction, where the information includes the date and the time, a currency amount, and an identifier for the merchant. For each transaction for which the date and time of the corresponding authorization response are within a predetermined time period, and for each identifier for the merchant, there is a deriving of the sum of the currency amounts by using the identifier for the merchant to access a database to retrieve (i) the logical address for the merchant, or its agent, corresponding to the identifier for the merchant and (ii) a business rule for making a contribution corresponding to an identifier for a contribution recipient or an affinity entity or charity having a logical address, wherein in the currency amount of each contribution is a function, at least in part, of the currency amount of each transaction. A transmission is made to the logical address for the merchant, or its agent, that includes the contribution to the contribution recipient or affinity entity or charity for the predetermined time-period. Within a predetermined audit time-period for and after the predetermined time-period, a plurality of contribution receipts are received, each including (i) the respective identifiers for the affinity entity or charity and the merchant and (ii) a currency amount. For each identifier for the merchant, the sum of the currency amounts of the contribution receipts for each identifier for the affinity entity or charity is derived.

The contribution to the contribution recipient or affinity entity or charity that the merchant is obligated to make to the contribution recipient selected by the consumer in exchange for the consumer conducting a transaction with the merchant will be a contribution in at least two (2) parts. The contribution is made in the first part to a fund to which the contribution recipient has ready access. The contribution recipient ready access fund can be used by the contribution recipient, preferably, without limitations on its use. The contribution by the merchant is made in the second part to an endowment trust for the benefit of the contribution recipient. The contribution recipient will preferably have limited access to the endowment trust. The access by the contribution recipient to the endowment trust will preferably be limited to a portion of income from investment of the principal in the endowment trust. The remainder of the income will preferably be added to the principal in the endowment trust for investment of the principal. In an alternative implementation of the foregoing, the contributing merchant's bifurcated obligation is to make a single contribution that is then split or bifurcated by a third party, such as by a community platform implementor, into two (2) different contributions. The two (2) different contributions are a first contribution that is made to a fund to which the contribution recipient has ready access, and a second contribution that is made to an endowment trust for the contribution recipient's long-term benefit and to which the contribution recepient has limited access. In a variation of the foregoing implementation, the single contribution by the merchant becomes the property of a community platform implementor. Thereafter the community platform implementor assesses an implementation fee (e.g., for community platform operational costs, etc.), and then remits the remainder to the two (2) different funds. In each such implementation, the contribution that is made by the merchant is ear-marked for use by the contribution recipient selected by the consumer in exchange for the consumer conducting the transaction with the merchant. In yet a further variation of the foregoing implementations, each contribution recipient that was selected by each consumer owns a share in an undivided interest in the whole of a consolidated endowment trust being held for each such contribution recipient's long-term benefit and to which each such contribution recipient has limited access.

In some implementations, the contribution to the contribution recipient or affinity entity or charity that the merchant is obligated to make to the contribution recipient selected by the consumer in exchange for the consumer conducting a transaction with the merchant will be matched by a like a contribution by a group in which the consumer is a member. In such implementations, the group is in a competition against one or more other groups. In such implementations, for each transaction conducted by the consumer with a merchant, for each group for which the consumer has a membership designed by a globally unique identifier, where each group is participating in a challenge or competition against at least one other group to make contributions matching that of merchants to affinity entities that are respectively selected by the consumers, an obligation of the group in which the one said account holder has membership is recorded. The obligation of the consumer's group that is recorded in each such competition or challenge is to make a matching contribution to the contribution that is made by the merchant in exchange for the transaction conducted by the consumer with the merchant.

After the predetermined audit time-period for the predetermined time, for each identifier for the merchant, and for each identifier corresponding to each contribution recepient or affinity entity or charity to whom a contribution was to be made as per the retrieved business rule, a determination is made of a difference between: (i) the contribution for the predetermined time period that was transmitted to the logical address of the merchant, and (ii) the sum of the currency amounts of the contribution receipts received for the affinity entity or charity for the predetermined time period. Then, the determined difference is transmitted to the logical address for the merchant, or its agent.

In various implementations, an account issued by an issuer to an account holder can be a revolving credit account, a debit account, a charge account, an Automatic Teller Machine (AMT) account, a prepaid account, a gift account, etc.

In other implementations, the affinity entities to which the merchant contributes can be limited to those within the merchant's community, within the account holder's community, within both communities, or within neither community. In still further implementations, the account holders can designate those affinity entities to which the merchant is to make a contribution, regardless of the location or charitable object or mission of the affinity entity. In yet other implementations, an acquirer for the merchant to a transaction can make the contribution on the merchant's behalf incident to clearing and settling the transaction with the issuer that issued the account to the account holder, and where, optionally, the acquirer's contribution can be in the form of an adjustment to exchange rate assessed to the merchant against the transaction amount for conducting the transaction on the account holder's account. Other participants in a payment processing system, including the issuer and the transaction handler, can similarly make contributions as further incentives to the account holder to conduct a transaction on the account holder's account.

In still further implementations, in an open loop cashless payment system for making charitable contributions, the merchant funds and makes direct payment of all contributions to the merchant's designated affinity entities or charities according to a merchant designated business rule, wherein, in a variation thereof, the merchant funds and makes direct payment of all contributions to merchant's designated affinity entities or charities that are located in, and/or provide services to, the merchant's neighborhood, which may be defined geographically or by other definitions.

In yet further implementations, in an open loop cashless payment system for making charitable contributions, the merchant funds and the merchant's acquirer makes direct payment, incident to a process of closing and settlement, of all contributions to all affinity entities or charities for those transaction conducted by account holders with the merchant on respective accounts issued to the account holder by respective issuers.

In still further implementations, in an open loop cashless payment system for making charitable contributions, the merchant funds the charitable contributions and the merchant's acquirer makes direct payment, incident to a process of closing and settlement, of all contributions to all charities for those transaction conducted by the account holders with the merchant on respective accounts issued to respective account holders by respective issuers, wherein, in a variation thereof, the contributions are made to those affinity entities or charities having a physical location within the merchant's neighborhood, which may or may not be a geographically defined community.

In yet further implementations, the merchant funds and makes direct payment of contributions to account holder-designated affinity entities for those transactions conducted by the account holder with the merchant.

In still further implementations, in an open loop cashless payment system for making affinity entity contributions, the merchant funds and makes direct payment of all contributions to all account holder designated charities for those transactions conducted by the account holder with the merchant on an account issued to the account holder by an issuer, wherein, in a variation thereof, the contributions are made to those charities having a physical location within the merchant geographically defined community.

In still further implementations, in an open loop cashless payment system for making affinity entity contributions, both the merchant and its acquirer fund bifurcated contributions to affinity entities, incident to a process of closing and settlement, of all contributions to all account holder designated affinity entities for those transaction conducted by the account holder with the merchant on an account issued to the account holder by an issuer, wherein, in a variation thereof, the bifurcated contributions are made to those affinity entities designated by the account holder, which affinity entities may have a physical location within a neighborhood where the account holder resides and the merchant's brick and mortar store is located. In a still further variation thereof, a downward adjustment is made to an exchange fee assessed to the merchant by the merchant's acquirer such that the merchant is able to pay a lower exchange fee to compensate for the merchant's affinity entities contribution, and, optionally, the acquirer for the transaction can also pay the same local affinity entities a bifurcated contribution out of increased transaction volume due to the incentive.

In yet further implementations, in an open loop cashless payment system for making affinity entities bifurcated contributions, the merchant funds and its acquirer makes direct payment, incident to a process of closing and settlement, of all bifurcated contributions to all account holder designated affinity entities for those transactions conducted by the account holder with the merchant on an account issued to the account holder by an issuer, wherein the account holder matches at least a portion of the merchant's contribution to the affinity entity or charity by the account holder's issuer making direct bifurcated payment to that affinity entity or charity incident to a process of closing and settlement such as by way of a charge for the account holder's affinity entities contribution that is rendered as a statement debit on the account holder's periodic revolving credit account statement.

Variations on the foregoing implementations include allowing the customer to specify one or more affinity entities (e.g., charities) that provide goods and/or services in their local community to which contributions are to made by merchants with whom the customer conducts transactions. In such implementations, each merchant is given notice of its total periodic obligatory contributions. Such notice, however, is given without providing the merchant with any notice or knowledge as to the specific identity of those affinity entities that are to be its recipients. Such implementations leave the direction of merchant's contributions fully within the discretion of the merchant's customers. In some implementations, the customer's discretion can be limited by the restriction that the customer can only select affinity entities from among those that serve the local community in common to both the merchant and the customer, while leaving the actual amount of the merchant's bifurcated contribution fully within the discretion of the merchant. Variations on such implementations include alternative definitions for the local community in common to both the merchant and the customer.

Still further variations on the foregoing implementations include deriving a bifurcated contribution to be made by the merchant to the affinity entity for a predetermined time-period by using a merchant contribution business rule as well as a rule previously specified by the account holder who conducts the transaction with the merchant. By way of example, and not by way of limitation, the merchant's contribution business rule might choose the amount of the contribution whereas the account holder's rule might choose the affinity entity that is not located in the same community of either the merchant or the account holder.

### BRIEF DESCRIPTION OF THE DRAWINGS

FIG. 1 is a flowchart illustrating an exemplary process that allow an account holder to make a purchase of goods and/or services from a merchant, where the account holder's transaction obligates the merchant to make a merchant-defined contribution to an affinity entity selected by the account holder, where the affinity entity may be a charitable organization (e.g., a charity);

FIG. 2 illustrates an exemplary payment processing system in which the process of FIG. 1 can be performed, where the system processes transactions conducted by merchants with account holders, wherein, for each transaction, there is a provision of a service and/or good by the merchant to the account holder for the transaction which is conducted on an account issued to the account holder by an issuer, there is an authorizing and remunerating of an electronic payment by the account holder in conducting the transaction on the account with the merchant, and there are one or more contributions by the merchant that are made to respective affinity entities or charities incident to the transaction;

FIG. 3a illustrates a screen shot characterizing an exemplary user interface for a merchant to designate terms and conditions under which the merchant will make a bifurcated contribution incident to each transaction with each account holder, where the contribution will be made an to affinity entity selected by the account holder;

FIG. 3b illustrates a screen shot characterizing an exemplary user interface for an account holder to specify one or more affinity entities to whom a bifurcated contribution will be made by a merchant with whom the account holder conducts a transaction on an account issued to the account holder;

FIG. 4a illustrates a screen shot characterizing an exemplary user interface for an account holder to specify one or more affinity entities to whom a bifurcated contribution will be made by a merchant with whom the account holder conducts a transaction on an account issued to the account holder, and optionally also for the account holder to specify one or more affinity entities to whom a bifurcated contribution by the account holder, limited within account holder specified time periods, will be made when the account holder conducts a transaction with the merchant on their account so as to match at least a portion of the bifurcated contribution by the merchant;

FIG. 4b illustrates a screen shot characterizing an exemplary user interface for a merchant to designate terms and conditions under which the merchant will make a bifurcated contribution incident to each transaction with each account holder, where the contribution is made to an affinity entity selected by the account holder, and where the distance between geographic locations corresponding to each of the account holder to the merchant can be calculated with real time traffic conditions for various modes of transportation;

FIG. 5a illustrates a screen shot characterizing an exemplary user interface for an account holder to specify the account holder's Globally Unique Identifier (GUID) which identifies the account holder's unique membership in a particular group participating in a fund raising competition, and where each transaction conducted by the account holder during the competition may obligate the merchant in the transaction, or other identified contributor(s), to make a contribution an affinity entity selected by the account holder;

FIG. 5b illustrates a screen shot characterizing an exemplary user interface for an account holder to review each transaction conducted on an account issued to the account holder with a merchant who is identified by a Globally Unique Identifier (GUID), where the merchant is obligated to a make a contribution to a contribution recipient (a.k.a., an affinity entity) selected by the account holder, where the contribution to the contribution recipient by the merchant can be defined by the merchant to be a percentage of the transaction amount of the transaction;

FIG. 6 illustrates an exemplary open loop payment processing system for transactions conducted by merchants with account holders, wherein, for each transaction, there is a provision of a service or good by the merchant to the account holder for the transaction on an account issued to the account holder by an issuer, and where there is an authorizing and remunerating of an electronic payment by the account holder in conducting the transaction on the account with the merchant;

FIG. 7 illustrates, for a merchant having a geographic address within one type of a low population density merchant-community, navigation algorithm time results for each of a plurality of transportation modes that might be used by an account holder to travel from a geographic address associated with the account holder to the geographic address associated with the merchant;

FIG. 8 illustrates, for a merchant having a geographic address within one type of a high population density merchant-community, navigation algorithm time results for each of a plurality of transportation modes that might be used by an account holder to travel from a geographic address associated with the account holder to the geographic address associated with the merchant;

FIGS. 9 and FIG. 11 are flowcharts each illustrating an exemplary process in which a vertical artificial intelligent agent is in communication with a plurality of network accessible databases, where the vertical artificial agent identifies patterns in data within the network accessible databases, and retrieves and operates on the corresponding data to identify, via one or more prediction algorithms, two or more competitors in a geographic region to compete in a competition during an identified time period, where the vertical AI agent calculates contributions by contributors incenting transactions conducted in the geographic region by account holders with merchants, where the contributions are to account holder selected affinity entities, and where the vertical AI agent calculates that the competition will have a probability that exceeds a first predetermined threshold for raising contributions from contributors to account holder selected affinity entities that exceeds a second predetermined threshold;

FIG. 10 illustrates a network environment in which a vertical artificial intelligent agent is in network communication with a plurality of network accessible databases, in which network environment the process seen in FIGS. 9 and 11 can be conducted;

FIG. 12 is a flow chart showing an exemplary implementation of various methods of contribution generation, including merchant-funded contributions and account holder loyalty contributions, where the contributions are funded by merchants after conducting transactions with account holders (e.g., consumers), and where the contributions are made to contribution recipients that are selected by the account holders;

FIG. 13 is an account schematic diagram illustrating an exemplary zero balance implementation of merchant accounts and an operating account, where the merchant accounts make contributions to receipt accounts after an incented transaction has been conducted the merchant with an account holder (e.g., a consumer), where an operating account makes bifurcated distributions of the contributed funds between the receipt accounts and a disbursement account;

FIG. 14 is a flow chart illustrating an exemplary process for a consumer transaction incented by contributing merchant being obligated to make a bifurcated contribution to a consumer-selected contribution recipient ready access fund and also to a consumer-selected contribution recipient endowment trust;

FIG. 15 illustrates exemplary systems housed within an interchange center to provide online and offline transaction processing for transactions conducted using the payment processing system illustrated in FIGS. 1, 2 and 6; and

FIG. 16 illustrates further exemplary details of the systems illustrated in FIG. 15.

Implementations will become more apparent from the detailed description set forth below when taken in conjunction with the drawings.

### DETAILED DESCRIPTION

In various computerized implementations, a vertical Artificial Intelligence (AI) agent operates on myriad databases to predict, for a competition between two or more competitor groups of debit/credit account holders, which competition is to take place in a geotargeted area during a specific calendar period, which competition has a probability exceeding a first predetermined threshold to raise funds contributed to account holder selected affinity entities, which contributed funds exceed a second predetermined threshold, which contributed funds are directed to affinity groups (e.g. charities) selected by the account holders, which contributed funds result from account holder transactions with merchants, and which transactions are incented by merchant agreements to make defined contributions to the geotargeted, account holder selected affinity entities. Using automatic data analysis, natural language processing, and predictive analytics, the vertical AI agent identifies patterns in the myriad databases to predict those competitor groups that are most likely (the first predetermined threshold) to raise statistically significant contributions (the second predetermined threshold) from merchant defined contributions to account holder selected charities. Each competitor group will preferably be composed of individual account holders, where each account holder is incented to conduct a transaction with a merchant who has an agreement to make a defined contribution to an affinity entity selected by the account holder. Moreover, the account holder is also incented to conduct a transaction with the merchant by a subjective motivation to win the competition, and to increase the likelihood that the account holder's competitor group will win the competition against other competitor groups by the account holder's competitor group raising more contributions from contributors than that of the other competitor groups.

As used herein, a vertical AI agent signifies a specialized form of artificial intelligence implemented as a specialized and targeted AI solution to operate within the domain or environment specified by various implementations and embodiments as disclosed in the present application. The vertical AI agent will preferably be implemented to perform specific functions specified in the present application by training on industry-specific data and incorporating deep domain knowledge by access to a myriad of network accessible databases to enable the vertical AI agent to make accurate predictions of significantly successful fund raising competitions between identified competitor groups of account holders conducting transaction with merchants, which competitions are described in the present application.

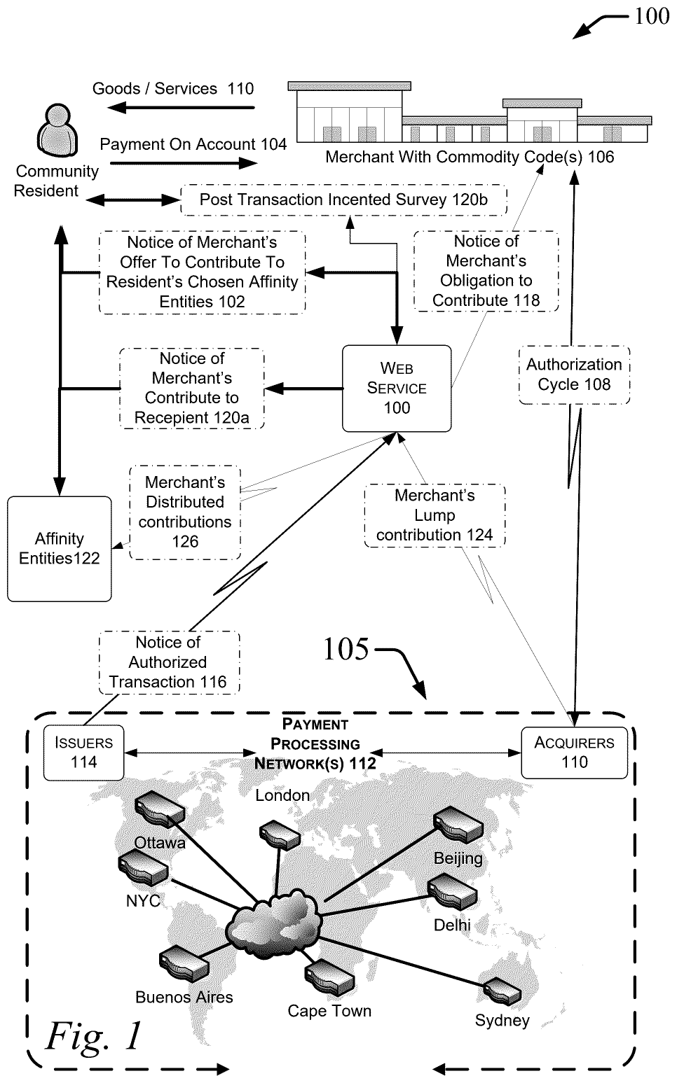

Referring now to FIG. 1, an environment is depicted for a global Acquired Account Payment Processing System 105 as shown. FIG. 1 shows a community resident who is incentivized to transact by way of a merchant's offer 102 to a make a contribution in exchange for the community resident purchasing goods and services 110 by the community resident's payment on an account 104 that was issued by an issuer 114 to the community resident. Note that, in some implementations, the merchant sets terms and conditions under which the merchant's contribution will be made, while the community resident selects one or more affinities entities to which the merchant's contributions are to be contributed. The community resident, who is an account holder, will conduct transactions with merchants on the account holder's debit and/or credit accounts, and may be still further incentivized to conduct such transactions because the account holder is a member of a competitor group in a competition to raise the most contributions than other such competitors, which contributions result from contributor-merchants after conducting transactions with those merchants who in turn make contributions to affinity entities selected by the account holder, in accordance with the enabling implementation disclosures herein.

The merchant, who may be operating a brick and mortar store in the community where the community resident resides, inputs data about the transaction on the community resident's account into a Point of Service terminal (POS) 106. The POS, for example, can be a cash register, a web-enabled mobile device (e.g., a tablet computing device), etc. The POS 106 transmits the input data, as part of an authorization request in an authorization cycle for the transaction, to an acquirer 110 for the merchant. Acquirer 110, who can be just one of many entities in the global Acquired Account Payment Processing System 105, sends the authorization request through a payment-processing network 112, as facilitated by one or more transaction handlers, for example Visa Net, to the issuer 112 who issued the account to the community resident. In response to the authorization request, the issuer 112 sends an authorization response at least of portion of which is ultimately sent for delivery back to the merchant's POS 106 by transmissions made in backward directions through the payment-processing network 112 via the merchant's acquirer 110.

If the transaction is authorized by issuer 114, an entity in the global Acquired Account Payment Processing System 105, such as the issuer 114, sends a message 116 containing particulars of the transaction to a Web Service 100 indicating that a transaction on the community resident's account was approved for being conducted by the community resident with the merchant whose offer to contribute may have been previously selected by the community resident.

Optionally, the data input into POS 106 can include additional monies received from the customer by the merchant that are also to be contributed, via the merchant, to a designated affinity entity 122 (e.g., a charity). In that case, message 116 would also contain these particulars.

Upon receipt of message 116, a contribution to the affinity entity 122 by the user's selected merchant is calculated according terms and conditions specified by the merchant.

Web Service 100 retains the derived contribution for subsequent audit purposes to ensure compliance by each community merchant in its contribution commitments to each of the one or more affinity entities or charities. The Web Service 100 may transmit a message containing notice of a contribution, or the particularly derived contribution, as shown at reference numerals 118-120 to respective logical addresses of the obligated merchant 106, one of more community resident/account holder designed affinity entities 122, and the community resident/account holder-and/or to respective agents thereof. The terms and conditions that obligate the merchant-offeror to make a contribution may, but need not, include discounts, rebates, or other monetary or non-monetary incentives. As such, the community resident/account holder is incentivized to purchase from the merchant's store, inter alia, by the merchant's agreement to contribute to one of more community resident/account holder designed affinity entities 122.

The affinity entity or charity, which may be selected at the discretion of the community resident/account holder, may be any entity to which the community resident has an affinity, regardless of where it is located or whom it serves. Alternatively, the affinity entity or charity may be limited to those organizations that provide a good and/or service to a community in which both community residences and merchants have an affinity—such as by their common geographic location, as by its geographic location being within a computed commuting time, by one more modes of transportation, that is below a predetermined time threshold. This affinity entity may provide food and clothing to underprivileged families in their common community. This affinity entity, for example, may provide teaching and demonstrations of entrepreneurial skills to community's unemployed or under employed.

Another affinity entity may provide venues where sports education can be provided to local competing youth. Yet another affinity entity may provide care and feeding to abandoned domesticated animals, such as pets. The affinity entity may also cultivate desirable citizenship and public policy through offerings of education and entertainment services—whether in person, on-line, or both. Given the foregoing, the reader will understand that the affinity entity can be either a for-profit or a non-profit organization, and may optionally be required to provide a good or a service to a local community to which both merchants and customers in the same community have an affinity, by their common location, to advance and/or promote the community.

In some implementations, each merchant will identify the affinity entity to whom the merchant-offer will make a contribution. To identify the affinity entity, a customer identifier, as received by Web Service 100 in message 116, can be used to look up or access information from which can be derived a geographic address in a community where the customer resides. Alternatively, the customer's geographic address can be an address that is associated with an account issued by an issuer to the customer upon which the transaction with the merchant is being conducted. As a still further alternative, the customer's geographic address can be an address specified by the customer as being the address that is to be used for the purpose of determining the customer's community, whereby the customer can self-select their own community by specifying a geographic address in the customer's self-selected community. Similarly, a merchant identifier, also received by Web Service 100 in message 116, can be used to look up or access information from which can be derived a geographic address in a community where the merchant-offer has a brick and mortar store. Alternatively, the merchant's geographic address can be an address that is associated with a merchant acquirer account issued by the merchant's acquirer to the merchant that will receive proceeds from the transaction with the customer that is being conducted. As a still further alternative, the merchant's geographic address can be an address specified by the merchant as being the address that is to be used for the purpose of determining the merchant's community, whereby the merchant can self-select its own community by specifying a geographic address in the merchant's self-selected community. These respective geographic addresses of customer and merchant, whether self-selected or otherwise, when retrieved from one or more network accessible databases, can be compared, using processes, procedures, and methodologies enabled herein, by Web Service 100, from information in or derived from message 116, to determine whether the merchant and its customer have the same local community. By way of example, data in message 116 can include an identifier for the customer, and a database of merchants and their respective merchant-offers can include geographic location information. This geographic location information is matched against the geographic location information for the residence of the customer. Merchant and customer identifiers can be assigned to the merchant and its customer during or prior to any transaction, such as when each are registered with or otherwise sign up for participation with Web Service 100. This registration process can include the collection of physical and logical addresses for each or for their respective agents.

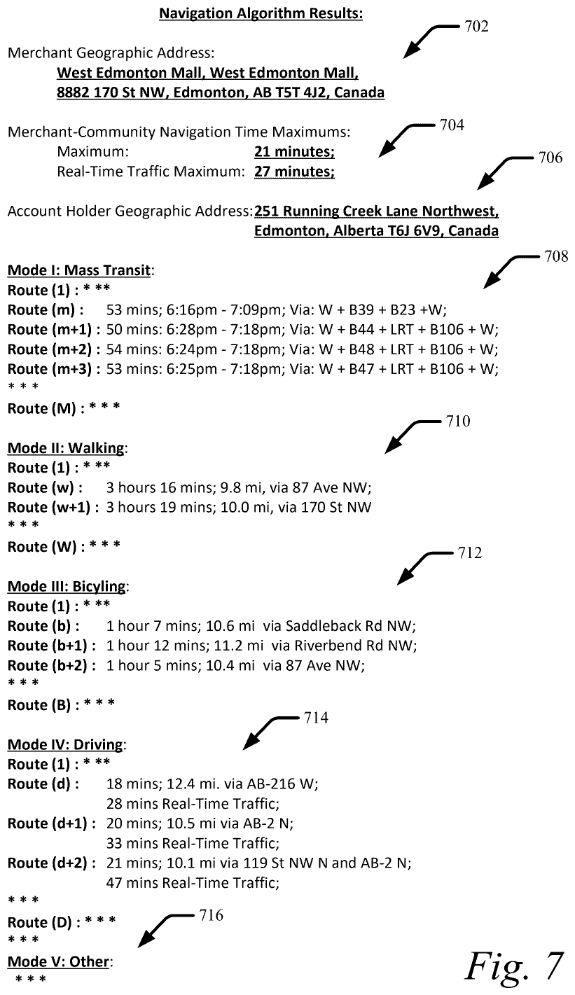

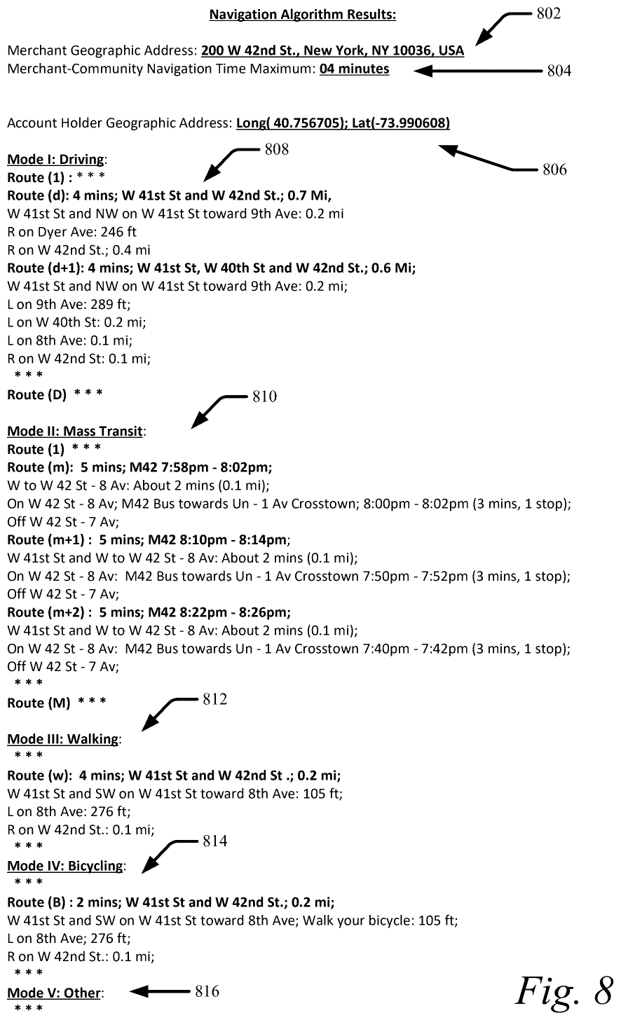

Once physical address information for the merchant-offeror and its customer are known, the local community of each of the merchant and its customer can be determined—in some implementations. Studies show that a significant portion of spending by a consumer is restricted to a region that is proximal to where the consumer resides. Accordingly, it is desirable for a merchant to attract those consumers who reside within the restricted region corresponding to the merchant's geographic location so that the customer can use a mode of transportation to travel from a geographic address of the customer's residence to the merchant's geographic location within a travel time that less than a threshold, as further discussed below with respect to FIGS. 7-8. As such, any such travel time that is less than the threshold might be understood to mean that the merchant-offeror and the customer who is traveling to the merchant-offeror are in the considered to be within the same community or the ‘Merchant-Community’.

Alternatively, the local community determination can be made on any of other different methods, or combinations thereof. Once such method is a political or legal division, that is, the merchant's place of business is determined to be in the same political or legal division as that of its customer's residence, such as the same province, state, county, prefecture, city, city-state, borough, etc. Another such comparison can be whether the merchant's place of business has a governmentally issued postal code that is the same, or within a predetermined proximity, as that of its customer's residence.

Yet another such comparison can be whether the merchant's place of business and its customer's residence are physically proximate within a predetermined factor by any of a variety of measures or combinations thereof. For example, latitude and longitude coordinates might be known for both the merchant's place of business and the residence of its customer. These coordinates can be used to determine whether the linear distance there between is within a predetermined distance to ascertain whether or not the merchant and its customer share the same local community.

As discussed above and for a further alternative, and also further discussed below with respect to FIGS. 7-8, a calculated navigation time algorithm, using any of various different travel methods (e.g., walking, automobile, bicycle, mass transit, etc.), can be used to determine whether the time, using any of one or more modes of transportation, is within a predetermined time limit to ascertain whether or not the merchant and its customer share the same local community, ‘neighborhood’, or Merchant-Community. By way of example, the merchant and its customer might be determined to be within the same local community if the automobile drive time, as determined from one or more databases of contemporary cartographic road system information, to navigate from a geographic address attributed to the attributed to the customer and a geographic address attributed to the merchant is less than a predetermined time threshold (e.g., 17 minutes), with yet another threshold that may be used to weight the navigation time calculations with real time traffic conditions data.

A further alternative implementation will identify the population density of both the merchant's brick and mortar store and the customer's residence. If the population density exceeds a predetermined density, then the merchant and its customer might be determined to be within the same local community if the time to walk, bicycle or take public transportation between the merchant's brick and mortar store and the customer's residence, as determined from one or more databases of contemporary topographic, mass transit, and/or pedestrian cartographic system information, is less than a predetermined time threshold (e.g., 55 minutes). Such implementations may also access databases to consider real time traffic conditions. Rural, industrial, city, and suburban environments will have different population densities, and likely modes of transportation, that correspondingly may have an effect on a travel time from a customer's resident to a merchant's geographic location. A further discussion is given below, in reference to FIGS. 7-8, relative to providing an incentive to customers living close by in exchange for traveling to, and transacting at, a merchant's store.

Still another such comparison can be whether the merchant's place of business and its customer's residence are proximate or are the same according to voting, electoral, or political districts. The district can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the merchant and its customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

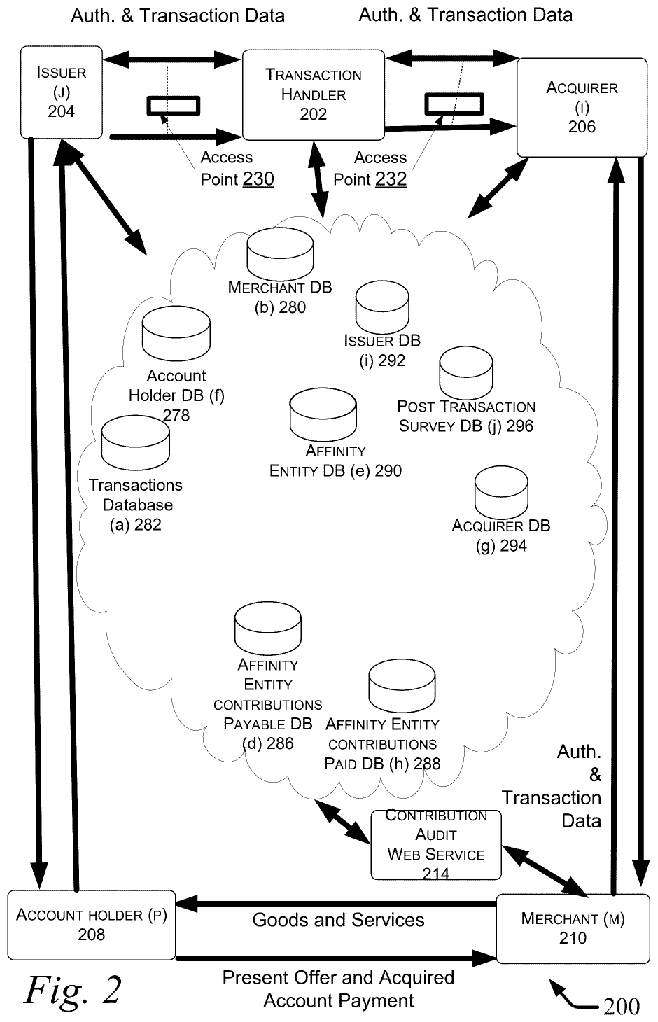

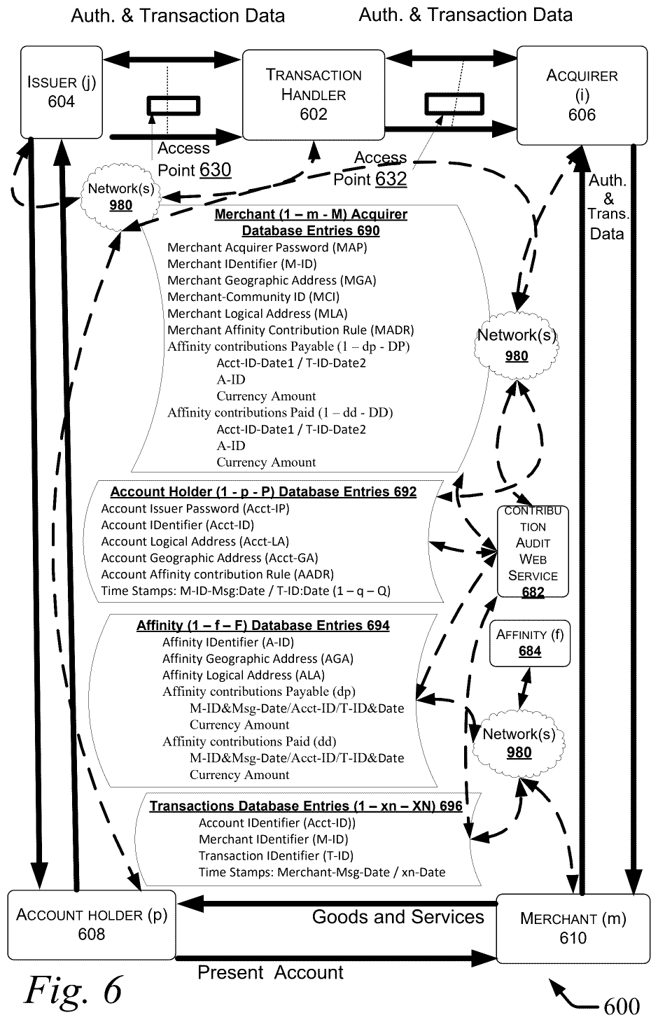

Similar or different algorithms that are used to determine the respective local community of the merchant and its customer can also be used to determine the local community of an affinity entity such as that shown on FIG. 1 at reference numeral 122, or as that shown as an Affinity Entity DB (d) 286 in FIG. 2, and an Affinity 684 in FIG. 6, as discussed herein below.

In some implementations, if the local community of the merchant, its customer, and an affinity entity that has been selected by the customer or by other methods are the same, then the business rule selected by the merchant will determine the amount of the contribution that the merchant will make to the selected affinity entity. In some implementations, the affinity entity to whom a merchant is to make a contribution can only be selected by the customer, and not the merchant. In such implementations, the goals or purposes of an affinity entity will not cause tension between the goals or purposes of the merchant or the goals or purposes of customer in that the identity of the affinity entity is unknown to the merchant through its being selected anonymously by the customer. As such, the merchant need not be told or be given any notice, directly or indirectly, as to the identity of the affinity, entity or charity selected the customer with whom the merchant is conducting a transaction. Rather, the merchant might only be told or be given notice to make a single payment of, or period payments to, a single affinity entity who, as trustee or agent, will thereafter make respective disbursements for all registered merchants accordingly to those affinity entities that had been selected by those customers with whom those merchants had conducted transactions.

Various implementations can ensure that a merchant who, by force of reason or conscience, does not want to make a contribution to a particular affinity entity or charity, need not do so directly, as any and all merchant contributions are made blindly through other avenues or collection points that make all merchant contribution disbursements to all affinity entities or charities. Accordingly, each merchant will have notice of its total periodic contributions without knowing the identity of the intended recipients, thereby leaving the direction of contributions fully within the discretion of the merchants' customers. Note that a limitation can optionally be placed upon the customer's choice of affinity entity or charity such that the choice must be made only among those affinity entities or charities that serve the local community of the merchant, its customer, or both. Such implementations may leave the currency amount of the merchant's contribution fully within the discretion of the merchant. Yet another limitation can optionally be placed upon the customer's choice of affinity entity or charity such that the choice must be made only among those affinity entities or charities that are on a pre-designated list of those organizations that are pre-approved by a third party as being available for such selection according to an approval process.

Web Service 100 can use respective identifiers for the merchant and its customer (e.g., account holder) to access and retrieve geographic information for each, and then apply an algorithm to the retrieved geographic information to determine the respective local communities of the merchant and its customer, as discussed above. By way of example, the local community can be progressively granular in nature, such as: 1^{st} the United States of America; 2^{nd} the state of New York; 3^{rd} the portion of New York called “Long Island”; 4^{th} the county of Nassau within the state of New York; 5^{th} a portion of the Nassau County called North Hempstead; and then 6^{th} the specific geographic location of “Port Washington”. This final level of geographic granularity indicates a community in which both merchant and customer are members, neighbors, residents, and/or the like.

The final level of geographic granularity can be used to perform a look-up against one or more databases to which Web Service 100 has access. This access and lookup is used by Web Service 100 to identify: (i) the affinity entity or charity for that community which, in this example, might be the Port Washington Food Bank located in Port Washington, New York, which charity might have been specified by the customer; and (ii) the respective identifier of the merchant's business rule (and/or the customer's business rule) that is to be used to make a calculation of the currency amount of the contribution that the merchant is to make to the affinity entity or charity for that community. Business rule(s) is/are used with the currency amount of the customer's payment in order to calculate the currency amount of the contribution that is to be made by the merchant to the affinity entity or charity for that community. Note that the contribution can be directed to a plurality of affinity entities for the local community according to directions that had been previously specified by the customer. For example, the customer may have specified that each merchant contribution is to be split evenly, or in specified portions totaling one hundred percent (100%), between five (5) local community affinity entities, for example: (i) a local youth sports team cooperative; (ii) a local charter junior high school; (iii) a local house of worship; (iv) a local political party; and (v) a local for-profit college specializing business entrepreneurialism.

Referring now to FIG. 1, the community resident can take the merchant's conditional offer 102 to the local merchant's brick and mortar store POS 106. After showing the offer 102 to the merchant at the POS 106, the community resident conducts a transaction on an account 104 issued by an issuer to the community resident to pay of the transaction and buy goods and/services 110 received by the community resident.

Note that terms and conditions of the transaction may differ from that of the offer presented by the community resident at the local merchant's brick and mortar store. As such, the merchant's offer to contribute might not be specific to a particular good or service, but can be specific as to the entire transaction between the merchant and its customer. By way of example as to this type of offer specificity, the offer may obligate the merchant to make a contribution of a certain percentage of the entire currency amount of transaction, or the offer may obligate the merchant to make a contribution only if the transaction is conducted at a certain time of day or on a particular day of the week, or only if the currency amount of the transaction exceeds a predetermined amount, or a combination of the foregoing. Other conditions are also permissible.

Although some terms of the offer may differ from some terms of subsequent transactions between the merchant and its customer, nevertheless, the merchant's offer to make a contribution to an affinity entity (e.g., a local charity) fundamentally provides an incentive that causes, at least in part, the local community resident to navigate to the local merchant's brick and mortar store, come into the store, shop, and ultimately conduct a transaction that will bring revenue to the local merchant and its community. Advantageously, the absence of specificity in the offer as to a particular good or service allows many implementations to operate without modification to the merchant's input of data about the transaction at the POS 106, without modifications to the POS 106 itself or procedures for its operation, and without modifications to software executing on POS 106.

Optionally, a community resident (e.g., customer) may accept the merchant's offer 102 in advance of going to the POS 106. Such advance acceptance may take place electronically, such as in response to the community resident's electronic receipt of offer 102. Such an electronic acceptance to offer 102 can be by way of a transmission of information from the community resident to the merchant. The transmitted information can include: (i) an identifier for the registered customer who intends to accept the merchant's offer 102; (ii) the calculated distance and/or time for the customer to navigate, using a known mode of transportation, from a geographic location associated with the customer (e.g., home location, work location, vacation location, etc.) to the merchant's brick and mortar store of the POS 106, for instance, by walking, bicycling, automobile and/or mass transit as further discussed below with respect to FIGS. 7-8; (iii) the terms and conditions of the offer including any expiration thereof; (iv) optionally any other information already conveyed to the customer, such as a statement about the contribution that the merchant will make to the Affinity Entity(ies) 122 when the customer conducts a timely transaction with merchant; and (v) other unexpired offers or advertisements that may or may not have been conveyed to the customer, terms and conditions of such other offer(s), etc.

Referring now to FIG. 2, an exemplary process 200 is depicted of a particular financial transaction system, such as may be described as an open loop system, in which an account holder (p) 208 conducts a financial transaction with a Merchant (m) 210. By way of example, the Account Holder (p) 208's financial transaction with the Merchant (m) 210 may have been incentivized by the Merchant (m) 210's agreement to make a contribution to an Affinity Entity (k) 295 in the local community as defined by the Merchant (m) 210 through an ad incentive which, optionally, can be communicated to Account Holder (p) 208, whether requested or not.

In FIG. 2, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 204-210 and 278-294, and 298 in FIG. 2 are illustrated with a block, but indicate one or more elements can be present. For example, Issuer (j) 204 is one of a possible plurality of issuers, where j may range from 1 to a large integer ‘J’.

Account Holder (p) 208 presents an account bearing payment device to a Merchant (m) 210 as tender for a financial transaction such as a purchase of goods and services. As part of the transaction, the Account Holder (p)'s 208 payment device can be a credit card, debit card, prepaid card, cellular telephone, Personal Digital Assistant (PDA), etc. Those of skill in the art will recognize that other financial transactions and instruments other than credit cards may also be used, including, but not limited to, a prepaid card, a gift card, a debit card, a token equivalent of an account as communicated via cellular telephony, near field communications, and the like. For purposes of illustration and explanation, however, reference will be made to a credit card.

The payment device can be manually keyed into a POS or can be read by a reader operated by the Merchant (m) 210, whereupon account information is read from the payment device and a request for authorization is transmitted to the Merchant (m) 210's Acquirer (i) 206. Each Acquirer (i) 206 is a financial organization that processes credit card transactions for businesses, for example merchants, and is licensed as a member of a Transaction Handler 202 such as a credit card association (i.e., Visa Inc., MasterCard, etc.) As such, each Acquirer (i) 206 establishes a financial relationship with one or more Merchants (n) 210.

The Acquirer (i) 206 transmits the account information to the Transaction Handler 202, who in turn routes the authorization request to the account holder's issuing bank, or Issuer (j) 204. The Issuer (j) 204 returns information via an authorization response to the Transaction Handler 202 who returns the information to the Merchant (m) 210 through the Acquirer (i) 206. The Merchant (m) 210, now knowing whether the Account Holder (p) 208's credit card account is valid and supports a sufficient credit balance, may complete the transaction and the Account holder (p) 208 in turn receives goods and/or services in exchange. Most credit card associations instruct merchants that, after receiving an affirmative authorization response, the detailed credit card account information obtained by a point of service terminal (e.g., such as via a magnetic stripe scanner) must be deleted.

To reconcile the financial transactions and provide for remuneration, information about the transaction is provided by the Merchant (m) 210 to Acquirer (i) 206, who in turn routes the transaction data to the Transaction Handler 202 who then provides the transaction data to the appropriate Issuer (j) 204. The Issuer (j) 204 then provides funding for the transaction to the Transaction Handler 202 through a settlement bank. The funds are then forwarded to the Merchant's (n) 210 Acquirer (i) 206 who in turn pays the Merchant (m) 210 for the transaction less a merchant discount, if applicable. The Issuer (j) 204 then bills the Account holder (p) 208, and the Account holder (p) 208 pays the Issuer 204 with possible interest or fees.

Also shown in FIG. 2 are one or more Affinity Entities (k) 298 and a Contribution Audit Web Service 214 that implement processes by which contributions to the one or more Affinity Entities (k) 298 from various contributors, for instance, any Issuer (j) 204, an Merchant (m) 210, any Acquirer (i) 206, and the Transaction Handler 202. Contribution Audit Web Service 214 implements processes for the auditing of contributions to the one or more Affinity Entities (k) 298. The Contribution Audit Web Service 214 has access to information resources within the following databases: Account Holder databases 278; Merchant databases 280; Transaction databases 282; Merchant-Community Geographic databases 284; Affinity Entity Contributions Payable databases 286; Affinity Entity Contributions Paid databases 288; Affinity Entity databases 290, issuer databases 292, acquirer databases 294, and post transaction survey databases 298.

By way of example, and not by way of limitation, Merchant-Community Geographic databases 284 may include construction of local, geographic, residential or community associations between merchants and their customers using factors such as geographic, political, demographics, navigational algorithms using local transportation modes that apply data for cartographic and geopolitical regions, urban population constituencies, rural population constituencies, industrial population constituencies, suburban population constituencies, planned communities, population density, cultural divides, racial population constituencies, census statistics, socio-economic factors, and combinations thereof.

As shown in FIG. 2, Databases 278-296 can be connected by one or more private or public networks, virtual private networks, the Internet, or by other means known to those skilled in the art. Moreover, not every entity seen in FIG. 2 at reference numerals 208, 210, 214 and 298 must necessarily have real time, uninterrupted access to any or all of the Databases 278-296. Each such Database 278-290 can assign, read, write, and query permissions as appropriate to the various entities. For example, a Merchant (m) 210 may have read access to the one or more Transactions Databases 282.

Each Transactions Database (a) 282 can be designed to store some or all of the transaction data originating at the Merchants (n) 210 that use a payment device for each transaction conducted between an Account holder (p) 208 and the Merchant (m) 210. The transaction data can include information associated with the account of an Account holder (p) 208, date, time, and an identifier sufficient to determine a physical geographic location where the transaction took place, among other more specific information including the amount of the transaction. The database can be searched using account information, date and time (or within proximity thereof), or by any other field stored in the database.

The Transactions Database (a) 282 is also designed to store information about each Merchant (m) 210, where the information can include a unique identification of each Merchant (m) 210, an identifier for each point of sale device in use by the Merchant (m) 210, and a physical geographic location of each store of the Merchant (m) 210.

Also included in the Transactions Database (a) 282 is account information for payment devices associated with Account holder (p) 208, such as part or all of an account number, unique encryption key, account information, and account name of an account holder who is registered to participate in a system in which contributions can be made to each Affinity Entity (k) 298 as per rules stored in Merchant Database (b) 280. After registering to participate in the contribution system, an Account holder (p) 208 initiates a qualifying purchase transaction with a Merchant (m) 210 by presenting a payment device (not shown) to the Merchant (m) 210. The payment device is typically presented at the Point Of Service terminal (POS) at which data thereon is read. Certain transaction information is transmitted from the POS (e.g., card track data) in route to the Merchant's (n) 210 Acquirer (i) 206. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 210, and the ultimate destination, such as the Acquirer (i) 206. These points can include, without limitation, from the reader at the POS, the POS at the Merchant (m) 210 and a network router or computer that is connected to a network but is housed and maintained by the Merchant (m) 210 and between the Merchant (m) 210 and the Acquirer (i) 206. The communication channel could be Ethernet, wireless internet, satellite, infrared transmission, or other known communication protocols. Some or all of the transmission may also be stored for record keeping, archival or data mining purposes with little or no encryption. For example, the Merchant (m) 210 may store transaction data, including certain account information in the Merchant's (n) 210 accounts on file database for reuse later.

During a transaction conducted by Merchant (m) 206 on an account issued by Issuer (j) 204 to Account Holder (p) 208, information relating to the qualifying purchase is retrieved from the POS at Merchant (m) 206. The transaction information is comprised of account information together with other information about the transaction itself: time, date, location, value, etc. Certain parts of the transaction information are considered sensitive information including, without limitation, account number, credit card verification number, and account name.

For the Account Holder (p) 208 to contribute to each Affinity Entity (k) 298 as may have been previously specified, the Account Holder (p) 208′s Issuer (j) 204 can pay the Affinity Entity (k) 286 and apply a debit in that currency amount on the Account Holder (p) 208's periodic revolving credit statement. The Account Holder (p) 208, upon receipt of the statement, can thereafter make a total payment to the Issuer (j) 204 of the currency amount of the contribution that appears as a debit on the statement along with the other credit charges that also appear on the Account Holder (p) 208's statement.

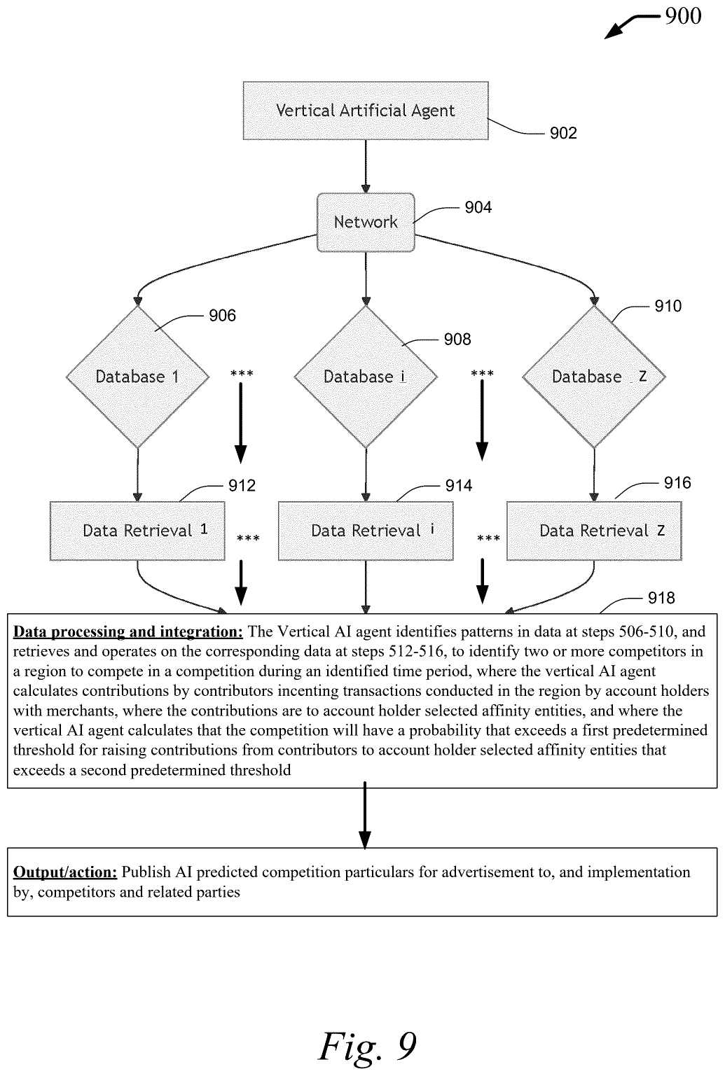

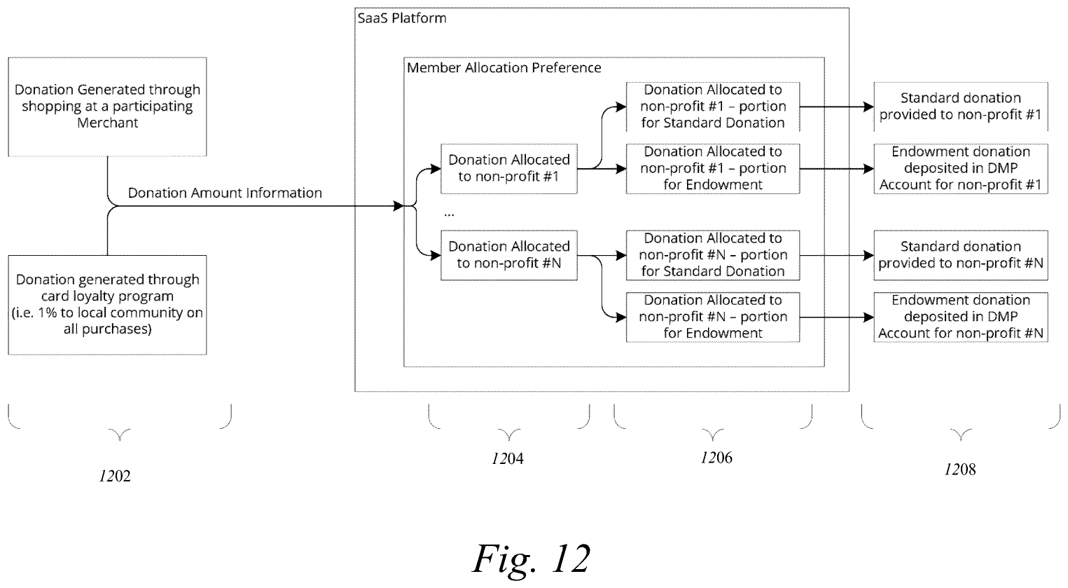

As discussed below with respect to FIGS. 9a-9b and 12a-12b, both the Account Holder (p) 208 and the Merchant (m) 210 can change or disable a contribution commitment at any time by accessing a server that serves web pages where respective user interfaces are provided. Thus, charitable contribution commitments can be enabled or disabled using real time user interfaces. By way of example, and not by way of limitation, such servers can be hosted by the Contribution Audit Web Service 214 seen in FIG. 2.

In various implementations, Contribution Audit Web Service 214 seen in FIG. 2 receives information that confirms such a timely transaction between the customer and the merchant by way of receiving information derived from an authorization response for the transaction. As more fully described elsewhere herein with respect to FIG. 2, the information in the authorization response is typically generated by an Issuer (j) 204 who issued an account to the Account Holder (p) 208 (e.g., the customer or mobile device user) on which the timely transaction with the Merchant (m) 210 was conducted. A positive authorization response reflects the Issuer (j) 204's approval of the transaction on the account issued to Account Holder (p) 208. Stated otherwise, and as shown in FIG. 2 and in discussion herein below, Contribution Audit Web Service 214 receives the information derived from an authorization response from an acquired account payment processing system (i.e., see Ref. Num. 105 in FIG. 1), where each of the Issuer (j) 204, the Account Holder (p) 208, and the Merchant (m) 210 operate in the acquired account payment processing system.

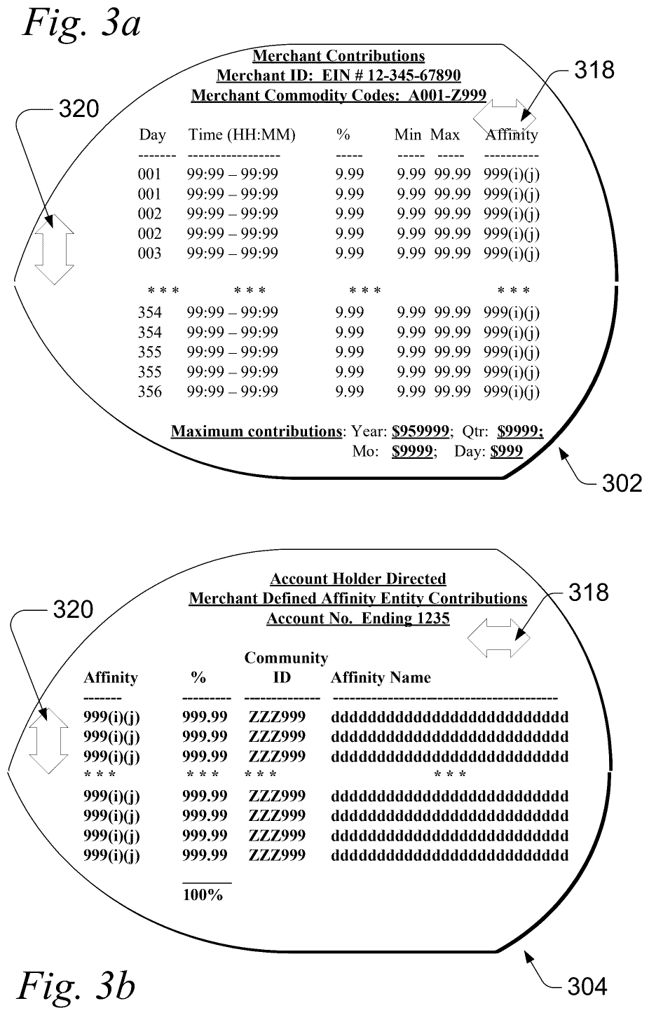

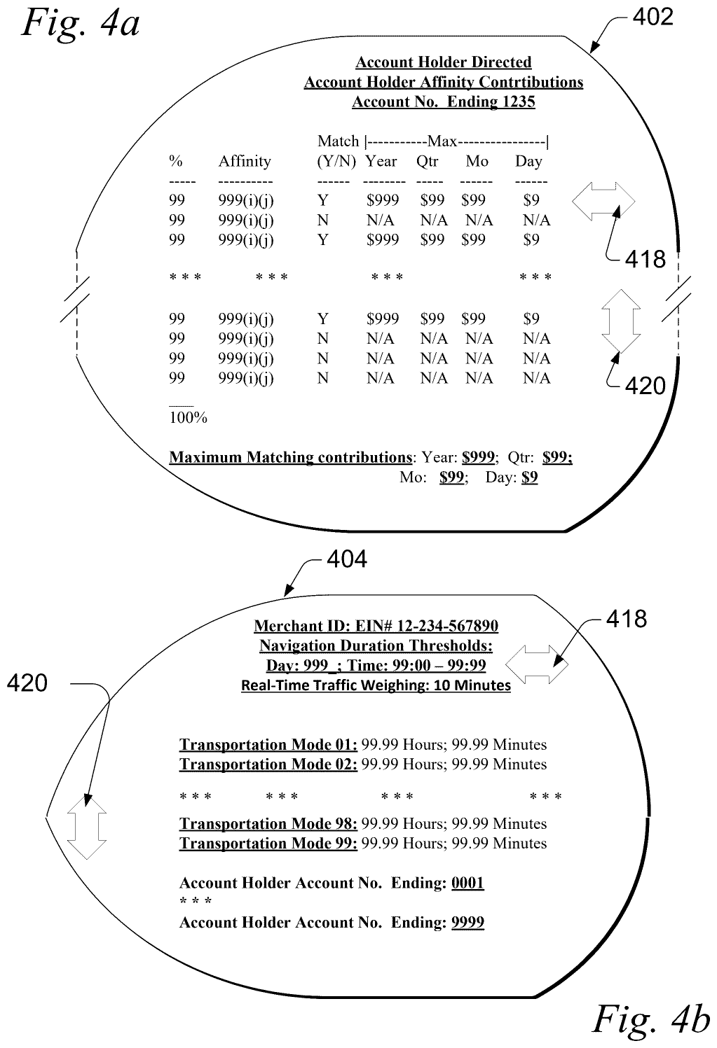

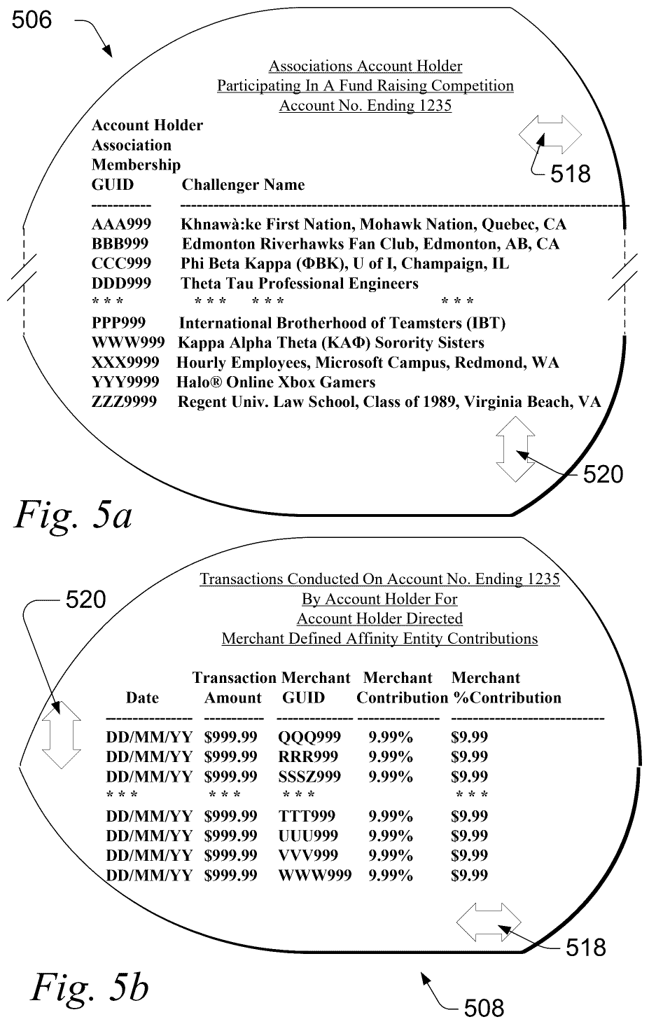

Once confirmation has been received by Contribution Audit Web Service 214 that a timely transaction has taken place been the merchant who made the offer and the customer who selected and confirmed that offer, a calculation is made of an amount of a contribution that is to be made by the merchant-offeror according to terms of the offer. By way of example, the terms of the offer to make the contribution to the community affinity entity or charity 298 may have been previously input for storage in Merchant DBs 280 by way of the merchant's user interface provided by an application executing on a computing device, such as in conjunction with screen shots seen in FIGS. 3b, FIG. 4a, and/or FIG. 5a as described herein below. To give notice of the contribution obligation that has arisen, the calculated contribution can be sent in one or more transmissions from Contribution Audit Web Service 214 to one or more logical addresses such as: (i) the Merchant (m) 210; (ii) the Affinity Entity (e) 290; (iii) the Customer or Account Holder (p) 208—or to respective agents thereof. Optionally, information that identifies the Affinity Entity (e) 290 and/or (iii) the Account Holder (p) 208 can be included in any such transmission.

Where the Affinity Entity (e) 290 to which the Merchant (m) 210 is obligated by the timely transaction to make a contribution is specified by the Account Holder (p) 208, the identity of the Affinity Entity (e) 290 need not be communicated to the Merchant (m) 210. Rather, the Merchant (m) 210 can make a blind contribution of the calculated amount to a third party for distribution to the Affinity Entity (e) 290 in the Account Holder (p) 208's residential community. By such blind, albeit obligatory, merchant contributions, conflicts and disagreements between Account Holder (p) 208 and Merchant (m) 210 as to right and proper objects of charity or affinity to the community can be avoided. As such, the Account Holder (p) 208 will transact with community Merchants 210 by way of incentives from the community Merchants 210 that they will contribute to the Account Holder (p) 208's favorite charity (e.g., Affinity Entity (e) 290), though the charity may not be the Merchant (m) 210's favorite charity, or even a desirable charity, in that community. Nevertheless, the Merchant (m) 210 has received the benefit of customers' foot traffic inside the merchant's local brick and mortar store, as well as the benefit of transactions with some of those customer who enter the merchant's brick and mortar store, where each such benefit is realized by the merchant's offer to make a contribution to the customer's favorite charity(ies) if a timely transaction occurs subsequent to the merchant's offer.

Referring to the screen shots FIGS. 3a-5b, with respect to FIG. 2, both the Account Holder (p) 208 and the Merchant (m) 210 can change or disable a contribution commitment at any time by accessing a server that serves web pages where respective user interfaces are provided. Thus, charitable contribution commitments can be enabled or disabled using real time user interfaces. By way of example, and not by way of limitation, such servers can be hosted by the Contribution Audit Web Service 214 seen in FIG. 2.

Once confirmation has been received by Contribution Audit Web Service 214 that a timely transaction has taken place been the merchant who made the offer and the customer who selected and confirmed that offer, a calculation is made of an amount of a contribution that is to be made by the merchant-offeror according to terms of the offer. By way of example, the terms of the offer to make the contribution to the community affinity entity or charity 298 may have been previously input for storage in Merchant DBs 280 by way of the merchant's user interface provided by an application executing on a computing device. To give notice of the contribution obligation that has arisen, the calculated contribution can be sent in one or more transmissions from Contribution Audit Web Service 214 to one or more logical addresses such as: (i) the Merchant (m) 210; (ii) the Affinity Entity 298; (iii) the Customer or Account Holder (p) 208—or to respective agents thereof. Optionally, information that identifies the Affinity Entity 298 and/or (iii) the Account Holder (p) 208 can be included in any such transmission.

Referring now to FIG. 3a, a screen shot 302 features input and displays fields by which a Merchant (m) 210, or agent thereof, can input terms and conditions under which the Merchant (m) 210 is willing to become legally bound to make a contribution to an Affinity (k) 298. Note also that the displayed information can automatically populated by access to and retrieval of data from one or more of the databases as pertains to the designation of entities corresponding to those communities to which account holders, merchants, issuers, acquirers, and other parties have affinities, where each contribution is made by a merchant to an entity incident to a transaction between an account holder and the merchant.

FIG. 3a shows fields for a field for Merchant Identifier which, by way of non-limiting examples, can be a government tax identifier, or other globally unique identifier, and a field for a Merchant-Community or Merchant Community Identifier (MCI). The MCI, by way of non-limiting example, can be a code to which is assigned a predetermined maximum travel time for a customer to travel from their residence to the merchant's address using any mode of transportation, as further explained above with respect to FIGS. 7-8.

Each row in screen shot 302 represent all or a portion of twenty-four (24) hour day of the calendar year. Columns in each row of the table seen in screen shot 302 are, from left to right, as follows: 1st the numerical calendar day of the year; 2nd the hyphenated starting and ending of a time period within the calendar day; 4th a percentage of a currency amount of any one (1) transaction that the Merchant (m) 210 will commit to make to an Affinity (k) 298; 5th the minimum currency amount of the transaction before the commitment by the Merchant (m) 210 to make the contribution will arise; 6th maximum amount of contribution that the Merchant (m) 210 is willing to make for any one (1) transaction; 7th an identifier for the Affinity (k) 298 to whom the Merchant (m) 210 is to make the contribution as described in the row.

By way of example, and not by way of limitation, the data input by the Merchant (m) 210, or agent thereof, for display on screen shot 302 can be stored in by way of Contributions Business Rules in Merchant DataBase (b) 280 or other location logically accessible, via one or more networks or otherwise, to Contribution Audit Web Service 214. These data can also be automatically pre-loaded for Merchant (m) 210 via an automatic initiating service that allows the Merchant (m) 210 to be entered as a participant in a local community contributions program through traffic each store location of the Merchant (m) 210 in the local community will be incentivized to increase.

Optionally, screen shot 302 can also be used by other contributors seen in FIG. 2, to input and see a display of those fields by which the contributor, or agent thereof, can input terms and conditions under which the contributor is willing to become legally bound to make a contribution to an Affinity (k) 298. Such other contributors include each issuer (j) 204, the transaction handler 202, and the acquirer (i) 206.

Referring now to FIG. 3a, screen shot 302, shows fields for a field for Merchant Identifier which, by way of non-limiting examples, can be a government tax identifier, or other globally unique identifier, and a field for a Merchant-Community or Merchant Community Identifier (MCI). The MCI, by way of non-limiting example, can be a code to which is assigned a predetermined maximum travel time for a customer to travel from their residence to the merchant's address using any mode of transportation, as further explained above with respect to FIGS. 7-8.

As seen in screen shots, each offer input by the merchant to contribute to a local affinity entity is not be specific to a particular good or service that the merchant will provide to its customer in a transaction. Rather, the offer is specific to the entire transaction between the merchant and its customer. By way of example as to this type of offer specificity, the offer may obligate the merchant to make a contribution of a certain percentage of the entire currency amount of transaction, or the offer may obligate the merchant to make a contribution only if the transaction is conducted at a certain time of day or on a particular day of the week, or a combination of the foregoing. Although some terms of the offer may differ from some terms of the transaction, nevertheless, the merchant's offer to make a contribution to a local affinity entity (e.g., a local charity) has the goal of fundamentally providing an incentive that causes, at least in part, the local community resident to navigate to the local merchant's brick and mortar store as new foot traffic, and ultimately to conduct a transaction that brings revenue to the brick and mortar store of the local merchant.

As shown in FIG. 3a, a merchant can designate, if each of several different time periods during each calendar day, the navigation time under which the merchant will make a contribution to one or more charities designated by a customer who transacts with the merchant, as well as the corresponding percentage of the transaction amount that the merchant will contribute. As such, a merchant can input data such that a greater or lesser contribution is made as depends up the time, the day, and the navigation time, by any of several different modes of transportation, between locations respectively associated with the merchant and the customer who transacts with the merchant.

Referring to FIG. 3b, and as stated above, studies show that the majority share of a community resident's annual spend, at least for some communities, tends to stay in their local community, a merchant in that community would like to incentivize residents in that community to conduct transactions with the merchant. As such, the merchant residing in a heavy-local spending community can choose to make an offer to any such community resident that a contribution will be made to one or more affinity entities or charities that are designated by the community resident. The merchant's contribution, however, can be made conditional. One such condition can be that the community resident resides in the community where the transaction is conducted with the merchant—where the community residence criteria are made upon a derivation of a specific navigation algorithm. A commercial reason behind the merchant's contribution incentive is to attract customers who are likely to be repeat customers who will frequently shop at the merchant's store. Although somewhat dependent upon the type of goods and services provided by the merchant, and the location where the merchant is physically located, the type of customer that is most likely to be a repeat, frequent customer might be determined to be one who lives or works relatively close to the merchant's store. As such, the screen shots seen in FIG. 3b provides input fields to receive incentives directed towards likely frequent shoppers, while disallowing contribution incentive to customer who will be unlikely to travel to the merchant's store frequently due to distance, difficulty of the commute, etc.

By way of exemplary implementation of data input to a field in screen shot 304 in FIG. 3b, a received identifier might identify a specific Affinity Entity (e) 290 that is located in, and provide goods and services to, the borough of Greenwich Village at the southern portion of the geographical island of Manhattan in the city of New York of the State of New York, in the USA. By way of example, and not by way of limitation, a Community ID represented by the character string “ZZZ999)” could have an interpretation representing progressively smaller communities, for instance, the United States of America, the state of New York, the City of New York, the combined boroughs of Manhattan, and the borough of Greenwich Village at the southern portion of the geographical island of Manhattan in the city of New York of the State of New York. The name of the specific Affinity Entity (k) 398 represented by Affinity Entity Code having the character string “999(i)(j)” and the affinity name shown in screen shot 1204b as “dddddddddddddddddddd” can be the “Washington Square Food Bank”, which may be located in, and provide goods and services to, the borough of Greenwich Village at the southern portion of the geographical island of Manhattan in the city of New York of the State of New York, in the USA.

As shown in FIG. 4a, a merchant can designate, if each of several different time periods during each calendar day, the navigation time under which the merchant will make a contribution to one or more charities designated by a customer who transacts with the merchant, as well as the corresponding percentage of the transaction amount that the merchant will contribute. As such, a merchant can input data such that a greater or lesser contribution is made as depends up the time, the day, and the navigation time, by any of several different modes of transportation, between locations respectively associated with the merchant and the customer who transacts with the merchant. Screen shot 402 in FIG. 4a shows a plurality of rows. Each row includes an affinity entity, the percentage of any contribution that the account holder requires to be made to that affinity entity, an identifier for a community associated with the affinity entity, and a description or name of the affinity entity. Note that the sum of the second column of the row must equal one hundred percent (100%).

Referring now to FIG. 4b, a merchant, or its agent, is enabled to input one more minimum and maximum navigation times for different times on different days of the year. Each input navigation time range is used to determine whether or not the merchant will be obligated to make a contribution to an affinity entity or charity. In practice, information derived from an affirmative authorization response for a transaction between the merchant and an account holder is obtained. This information will contain sufficient data that can be further used to retrieve and/or determine physical address information for the merchant and the account holder. Once physical address information for the merchant and the account holder customer are known, these physical addresses are used with a navigation time algorithm to determine the navigation time from the physical address of the account holder to the physical address of the merchant. If the determined navigation time does not exceed the maximum navigation time (which may be weighted by real-time traffic conditions) for one or more transportation nodes seen in the middle of screen shot 420 in FIG. 4b, and the date and the time of the transaction are within a time period and day which may have been previously specified by the merchant's input for the particular day and time as shown at the top of screen shot 420, then the merchant will be obligated to make a contribution to an affinity entity or charity. Otherwise, the merchant is not obligated to make a contribution to an affinity entity or charity.

FIG. 4b allows a merchant to input different navigation time thresholds for any of several different kinds of transportation modes, such as walking, driving, mass transit, and there combinations. For instance, if at least one of the navigation times from a customer's residence to the merchant's store for different transportation modes is less that an input threshold, then the merchant will make a contribution to the customer's identified charities after the customer's transaction with the merchant has been authorized.

The one or more different transportation modes seen in screen shot 420 in FIG. 4b each show a maximum navigation times for different transportation modes. One such transportation mode can be by automobile, another by walking, and other by mass transit, another by a specific combination of different transportation modes (e.g., walk, subway, bus, and walk), etc.

Referring now to FIG. 5a, a screen shot 506 features input and displays fields by which an Account Holder (p) 308, or agent thereof, can specify the Account Holder (p) 208's Globally Unique Identifier (GUID) which identifies the Account Holder (p) 208's unique membership in each of the exemplary groups shown in respects rows of FIG. 5a. Each such group competite in a competition the particulars of which are identified by a vertical AI agent. Note, optionally, the group may also be obligated to make a matching contribution, or portion thereof, to that of the Merchant (m) 210 with whom the Account Holder (p) 208 conducts a transaction on an account issued to the Account Holder (p) 208. Stated otherwise, each group in which the Account Holder (p) 208 is a member may have an optional commitment to be legally bound to make a contribution to an Affinity Entity (k) 290 selected by the Account Holder (p) 208 as described herein.

In practice, the vertical AI agent will identify groups to challenge and compete against one or more other groups to a fund raising competition for affinity entities selected by the account holders of each group. Each such competition will be won by the amount of money contributed by the winning group. The winning group's total contributions during a particular date range will be the sum of the winning group's contributions, where each such contribution matches that of the Merchant 210's with whom the groups member-Account Holders 208 conducted transactions. By way of each such competition, the single contribution incentive that was offered to the Account Holder (p) 208 by the Merchant (m) 210 in exchange for the Account Holder (p) 208 conducting a transaction on the account issued to the Account Holder (p) 208 will result in a multiplication of that single contribution for as many competing groups in which the Account Holder (p) 208 is a member.

By way of example, and not by way of limitation, a One Hundred Dollar ($100.00) credit card payment to a restaurant by a diner will result in a two percent (2%) contribution, that is Two Dollars ($2.00), that is contributed by the restaurant to the diner's favorite charity, for instance, the local food bank in the diner's local community. By way of a challenge that is then underway, which challenge was instituted by respective groups in which the diner is a member, where the diner is a member of twenty-five (25) such groups, where each of the twenty-five (25) groups has agreed to make a matching contribution to that of the restaurant, then the $2 contribution to the local food bank by the restaurant will be multiplied by twenty-five (25) to result in a total contribution of Fifty Dollars ($50.00) to the local food bank. As such, the diner's $100 credit card payment is leveraged into a $50 contribution to the local food bank in the diner's local community.

Continuing with the above exemplary implementation, when one hundred (100) diners in the same local community agree to make respective one hundred dollar ($100) credit card payments to respective restaurants who have also agreed to make a two percent (2%) contribution to the local food bank in those diners' local communities, and when each diner is also member of twenty-five (25) groups that are presently in competition against other groups, the local food bank receives a Five Thousand Dollar ($5,000.00) contribution (e.g., $2 contribution×100 diners×25 groups). As disclosed elsewhere herein, the $5,000 contribution is bifurcated toward: (i) a fund to which the local food bank has ready access; and (ii) toward an endowment trust to which the local food bank has limited access.

Still continuing with the above exemplary implementation in a variation thereof, when the competition is a challenge by the National Hockey League (NHL) to season ticket holders of respective NHL clubs, where the challenge is proposed by the NHL to take place on a forthcoming New Years Eve, where a matching contribution is agreed to be made by the NHL itself, where a matching contribution is agreed to be made by each of the NHL clubs, and where a matching contribution is agreed to be made by each of the season ticket holder diners, when one hundred (100) cities each have one hundred (100) different season ticket holder diners in the same local community on the forthcoming New Years Eve, when each season ticket holder diner has a $100 credit card payment to a respective restaurant who has agreed to make a two percent (2%) contribution to the local food bank in that diner's local community, and where the one hundred (100) different diners in each of the one hundred (100) cities are season ticket holders in respective NHL clubs as follows: twenty-five (25) diners are Chicago Black Hawk season ticket holders, thirty-five (35) diners are Vegas Golden Knights season ticket holders, and forty (40) diners are Seattle Kraken season ticket holders, then (i) each restaurant makes a $2 contribution for each season ticket holder diner making a $100 credit card charge to the restaurant; (ii) each of the 100 season ticket holder diners in each of the 100 different cities makes a $2 matching contribution with their $100 credit card payment, that is, a $2 contribution×100 season ticket holder diners×100 cities, totaling $20,000; (iii) the NHL makes a matching contribution of $2 times for each of the 100 season ticket holder diners for each of the 100 different cities, that is, a $2 contribution×100 season ticket holder diners×100 cities, totaling $20,000; and (v) the respective NHL Clubs make the following matching contributions: (a) a $2 contribution for each of the twenty-five (25) Chicago Black Hawk season ticket holder diners in each of the 100 different cities, that is, a $2 contribution×25 Chicago Black Hawk season ticket holder diners×100 cities, totaling $5,000; (b) a $2 contribution for each of the thirty-five (35) Vegas Golden Knights season ticket holder diners in each of the 100 different cities, that is, a $2 contribution×35 Vegas Golden Knights season ticket holder diners×100 cities, totaling $7,000; and (c) a $2 contribution for each of the forty (40) Seattle Kraken season ticket holder diners in each of the 100 different cities, that is, a $2 contribution×40 Seattle Kraken season ticket holder diners×100 cities, totaling $8,000.

Given the foregoing, the New Years Eve NHL challenge to each season ticket holders has resulted in money raised for local foods banks in the 100 different cities in the amount of eighty thousand dollars ($80,000) as follows: (A) restaurant contributions of $2×100 season ticket holder diners×100 cites=$20,000; (B) season ticket holder diners matching contributions of $2×100 diners×100 cites=$20,000; (C) a NHL contribution of $2×100 season ticket holder diners×100 cites=$20,000; (D) $2 contribution by the Chicago Black Hawks NHL club for each of the twenty-five (25) Chicago Black Hawks season ticket holder diners in each of the 100 different cities, that is, a $2 contribution×25 diners×100 cities, totaling $5,000; (E) a $2 contribution by the Vegas Golden Knights NHL club for each of the thirty-five (35) Vegas Golden Knights season ticket holder diners in each of the 100 different cities, that is, a $2 contribution×35 diners×100 cities, totaling $7,000; and (F) a $2 contribution by the Seattle Kraken NHL club for each of the forty (40) Seattle Kraken season ticket holder diners in each of the 100 different cities, that is, a $2 contribution×40 diners×100 cities, totaling $8,000.

Given the foregoing continued exemplary implementation, the winners of the New Years Eve NHL challenge are the Seattle Kraken season ticket holders. New Years Eve dining by the Seattle Kraken season ticket holders resulted in thirty-two thousand dollars ($32,000) in contributions to their respective local foods banks by way of four (4) separate contributions of eight thousand dollars ($8,000) as follows: (i) a $2 contribution by each of 100 restaurants for 40 Seattle Kraken season ticket holder diners in each of one hundred (100) different cities (e.g., $2×100×40=$8,000); (ii) the forty (40) Seattle Kraken NHL club season ticket holders matching contributions; (iii) the Seattle Kraken NHL club matching contributions; and (iv) the NHL matching contribution. Stated otherwise, thirty-two thousand dollars ($32,000) of the eighty thousand dollars ($80,000) contributions to local food banks are attributable to the Seattle Kraken season ticket holders who are the winners of the New Years Eve NHL challenge.

Referring now to FIG. 5b, a screen shot 508 features input and displays fields for the Account Holder (p) 208, or agent thereof, to review each transaction conducted on an account issued to the Account Holder (p) 208 with a Merchant (m) 210. The Merchant (m) 210 is identified in FIG. 5b by a Globally Unique Identifier (GUID). The Merchant (m) 210 is legally obligated to a make a contribution to a contribution recipient, that is, to an Affinity Entity (k) 290 selected by the Account Holder (p) 208 as described herein. Preferably, the contribution to Affinity Entity (k) 290 by the Merchant (m) 210 is a percentage of the transaction amount of the transaction although, in different embodiments, the Merchant (m) 210 can define a different type and/or contribution amount to be contributed to Affinity Entity (k) 290 by the Merchant (m) 210.

Referring now to FIG. 6, a merchant automatic loyalty boarding entity sends a transmission that includes the MAP to the logical address for the merchant's acquirer. In response to receiving the MAP, the merchant's acquirer uses the MAP to access one or more databases so as to retrieve therefrom a Merchant-Identifier (M-ID) for the merchant, a Merchant Logical Address (MLA) for the merchant, a Merchant Geographic Address (MGA) for the merchant, a Merchant-Community Identifier (MCI) for the merchant, and a Merchant Affinity Contribution Rule for the merchant. By way of non-limiting example, a database has a plurality of Merchant Acquirer Database entries 690 as shown in FIG. 6. Each such entry 690 includes, for one Merchant (m) 610, a MAP, as well as a Merchant IDentifier (M-ID), a Merchant Geographic Address (MGA), a Merchant Logical Address (MLA), a Merchant-Community Identifier (MCI), a Merchant Affinity Contribution Rule (MADR). Optionally, a Merchant Commodity Code (MCC) can also be kept for one or more such merchants. Note also that each entry 690 can have one or more sub-entries (dp) and (dd) for Affinity Contributions that are both Payable and Paid, respectively, and where ‘dp’ and ‘dd’ are integers having a value from 1 to ‘DP’ and ‘DD’, respectively. By way of non-limiting example, each Affinity Contribution Payable, and each Affinity Contribution Paid, in one entry 690 can include: (i) the date that the Account Holder (p) 608 (Acct-ID) was sent an Affinity Contribution Message from Merchant (m) 610 (M-ID); (ii) the date that Account Holder (p) 608 (Acct-ID) conducted the transaction with the Merchant (m) 610 (M-ID); (iii) the identifier of the entity of affinity, Affinity (f) 684, (A-ID) to whom the contribution is to be made by the Merchant (m) 610; and (iv) the currency amount of that contribution (Currency Amount).

By way of example, each merchant can have an initial, auto-boarded, Merchant-Community Identifier (MCI). This auto-boarded MCI can be predetermined, for instance, according to the population density of a geographic address with which the merchant is associated. Thereafter, the merchant can later modify the auto-boarded MCI using a user interface as discussed herein below. The MCI for the merchant can be defined by a maximum time that a customer needs to travel from the residence of the customer to a geographic location attributed to the merchant. The merchant's MCI can be compared to the travel time from the residence of each customer who transacts with the merchant such that the merchant will not be obligated to contribute one or more customer selected entities if the customer's travel time, by one or more modes of transportation, as derived by any of a variety of navigation time algorithms using available cartographic data, which data may be weighted by real time travel and travel conditions, exceeds the merchant's MCI. As such, the merchant's MCI attempts to incent customers who live close by and are therefore most likely to transact with the merchant, as further discussed below with respect to FIGS. 7-8.

The MAG is used to access one or more databases so as to retrieve therefrom the Affinity-ID (A-ID). The A-ID corresponds to an entity having an affinity to which a merchant and/or an account holder belong. The affinity can be a community, such as a geographic community, to which the merchant and/or the account holder belong. The A-ID is used to gain access one or more databases and retrieve information therefrom, such as by sending transmissions that include the A-ID to logical addresses that include, for instance, the Affinity-ID (A-ID) and the Affinity Geographic Address (AGA). By way of non-limiting example, a database has a plurality of Account Holder (p) database entries 694 as shown in FIG. 6. Each entry 694 can include, for each Affinity (f) 684, an Affinity IDentifier (A-ID), an Affinity Geographic Address (AGA), and an Affinity Logical Address (ALA). Note also that each entry 694 can have one or more sub-entries (dp) (dd) for Affinity Contributions that are both Payable and Paid, respectively, and where ‘dp’ and ‘dd’ are integers having a value from 1 to ‘DP’ and ‘DD’, respectively. By way of non-limiting example, each Affinity Contribution Payable, and each Affinity Contribution Paid, in one entry 694 can include: (i) the date that the Account Holder (p) 608 (Acct-ID) was sent an Affinity Contribution Message from Merchant (m) 610 (M-ID); (ii) the date that Account Holder (p) 608 (Acct-ID) conducted the transaction with the Merchant (m) 610 (M-ID); (iii) the identifier of the Account Holder (p) 608 (Acct-ID) conducting the transaction with the Merchant (m) 610 (M-ID); (iv) the identifier of the Merchant (m) 610 (M-ID) conducting the transaction with the Account Holder (p) 608 (Acct-ID); (v) the identifier of the transaction (T-ID); and (vi) the currency amount of that contribution (Currency Amount).

Logical addresses corresponding to account holders are sent messages containing information as to the merchants' intentions to make contributions to one or more entities having an affinity, for instance, to the account holder and/or the merchant. By way of non-limiting example, a transmission is made to the logical address of each account holder with an account having a geographic address corresponding to the geographic address of the merchant (e.g., the customer's travel time does not exceed the merchant's MCI as further discussed below with respect to FIGS. 7-8), where the message sent to the account holder is derived at least in part from affinity contribution information.

The affinity contribution information can include an identification of the entity to which the merchant will make a contribution, which contribution can be a function, at least in part, of the currency amount of a transaction conducted between the account holder and the merchant on an account issued by an issuer to the account holder. The account holders can be so contacted by access to, and use of information in, a database having a plurality of Account Holder (p) Entries 692 as seen in FIG. 6. The message that is sent to the account holder in step 516 can include the non-monetary consumer incentive that merchant's contribution will be good for the community to which the account holder and/or the merchant have an affinity, thereby inducing the account holder's loyalty to the merchant.

By way of non-limiting example, each Account Holder (p) Database entry 692 can include, for each Account Holder (p) 608, an account Issuer Password (Acct-IP), and an Account IDentifier (Acct-ID), an Account Logical Address (Acct-LA), an Account Geographic Address (Acct-GA), and an Account Affinity Contribution Rule (AADR). The Account Holder (p) 608 can supply its Acct-IP, as well as each of its Acct-IDs for use of the Merchant (m) 610 and/or the merchant's Acquirer 606 so that the Account Holder (p) 608 will be able to receive messages about each Merchant (m) 610 who will make a contribution to an entity with whom the Merchant (m) 610, the merchant's Acquirer (i) 606, and/or the Account Holder (p) 608 has an Affinity (f) 684. Note also that each entry 692 can have one or more sub-entries (q), where ‘q’ is an integer from 1 to Q, Each subentry (q) for entry 692 can include: (i) the date that the Account Holder (p) 408 (Acct-ID) was sent an Affinity Contribution Message from Merchant (m) 610 (M-ID); (ii) the date that Account Holder (p) 608 (Acct-ID) conducted the transaction with the Merchant (m) 610 (M-ID); and (iii) the currency amount of that contribution (Currency Amount). Having retrieved various data stored in one or more databases as pertains to each Merchant (m) 610 and each Account Holder (p) 608, corresponding fields can be automatically populated (i.e., boarded) for storage in records of particular files in one or more of the databases.

The account holders, having received and been incented by the affinity contribution messages, will begin to transact with the merchants. For each of a plurality of such transactions, an Authorization Response is received. Information in the Authorization Response will be examined to determine whether the transaction was conducted by an Account Holder (p) 608 who had previously received an affinity contribution message from a Merchant (m) 610 on a date that was within a predetermined time range from the date of the transaction. This examination will be used to determine whether the Merchant (m) 610 is obligated to make a contribution to an affinity (f) 694 that will be good for a community to which the Account Holder (p) 608 and/or the Merchant (m) 610 has an affinity.

The affinity contribution information can include an identification of the entity to which the merchant will make a contribution, which contribution can be a function, at least in part, of the currency amount of a transaction conducted between the account holder and the merchant on an account issued by an issuer to the account holder. The account holders can be so contacted by access to, and use of information in, a database having a plurality of Account Holder (p) Entries 692 as seen in FIG. 6.

A transaction database entry (n) 696 is stored for each such Merchant (m) 610 who is determined to be obligated to make such a contribution to the affinity (f) 684, where ‘n’ is an integer from 1 to N. Each transaction database entry (n) 696 can include: (i) the Account IDentifier (Acct-ID) such a Primary Account Number or PAN of the Account Holder (p) 608; (ii) a Merchant IDentifier (M-ID) for the Merchant (m) 610; (iii) an IDentifier for the transaction (T-ID); (iv) the date (Merchant-Msg-Date) that the Account Holder (p) 608 (Acct-ID) was sent an Affinity Contribution Message from Merchant (m) 610 (M-ID); and (v) the date (xn-Date) that Account Holder (p) 608 (Acct-ID) conducted the transaction with the Merchant (m) 610 (M-ID).

FIG. 6 shows, by double headed arrows, authorization and transaction data movement between and among Issuer (j) 604, Transaction Handler 602, Acquirer (i) 606, and Merchant (m) 610, in which Account Holder (p) 608 offers to conduct a cashless transaction with Merchant (m) 610 on an account issued by Issuer (j) 604 to Account Holder (p) 608. Merchant (m) 610 initiates an authorization request to determine whether the Issuer (j) 604, in an authorization response to the authorization request, will authorize the transaction.

By access to, and examination of, various database entries 690-696, the determination can be made as to whether the cashless transaction was conducted by an Account Holder (p) 608 who had previously received an affinity contribution message from a Merchant (m) 610 on a date that was within a predetermined time range from the date of the transaction. If this examination finds that this is true, then a derivation will be made, using the Affinity Contribution Rule and the currency amount in the Authorization Response, of an Affinity Contribution currency amount. Optionally, the Affinity Contribution Rule may dictate that no contribution will be made unless the currency amount in the Authorization Response is large enough to justify that the contribution.

Once the Affinity Contribution currency amount has been derived, a message will be sent to the logical address for the Affinity-ID that includes both the derived Affinity Contribution currency amount and, optionally, the Merchant-ID. A message will also be sent to the logical address for the Merchant-ID that includes both the derived Affinity Contribution currency amount and the Affinity-ID. A pairing of these messages can be audited to ensure that the merchant's expected contributions to the entity of affinity will be properly paid by the merchant or an agent thereof. By way of example, FIG. 1 illustrates a method for one implementation of such an audit process. By way of non-limiting example for an exemplary audit process, Merchant Acquirer Database 690 shows allotment for a plurality of Affinity Contributions Payable (for an M-ID and corresponding currency amount) and Affinity Contributions Paid (for an M-ID and corresponding currency amount), and Affinity Database 694 shows allotment for a plurality of Affinity Contributions Payable (for an M-ID and corresponding currency amount) and Affinity Contributions Paid (for an M-ID and corresponding currency amount). When a contribution is to be made by the Merchant (m) 610 to affinity (f) 684, the Account Holder (p) 608 can be sent a survey.

FIG. 7 illustrates, for a Merchant having a geographic address within one type of a low population density Merchant-Community, navigation algorithm results for each of a plurality of transportation modes for a geographic address associated with an account holder. By way of example, the specific type of low population density might derived from accessible private and/or government data as being a mixed suburban and light industrial demographic that is in turn used in order to auto-populate predetermined and corresponding Merchant-Community Navigation Time Maximums as shown at reference numeral 704.

Reference numeral 702 shows a geographic address attributed to a merchant and reference numeral 706 shows a geographic address attributed to an account holder. Reference numeral 704 shows a Merchant-Community Identifier that includes a maximum travel time with and without real time travel conditions weighting. In some implementations, the merchant has no obligation to make a contribution to one or more customer selected affinity entities unless the customer's travel time, using at least one of the modes of transportation I though V as seen, respectively, at reference numerals 708-716, is not greater than the maximum(s) at seen at 704. As such, the merchant will incent only those customers who live close by in terms of travel time. Stated otherwise, the merchant's incentive is given only to a customer who is more likely to spend a significant portion of their spending at merchants who have a location that is close to where the customer resides in terms of travel time by any likely mode of transportation that the customer will use to travel to those merchants' locations.

Reference numeral 708 shows respective calculations for different routes 1 through M for a mass transit mode of transportation, where each calculation is for a travel time using mass transit as the mode of transportation from address 706 to address 702.

Reference numeral 710 shows respective calculations for different routes 1 through W for walking as a mode of transportations, where each calculation is for a travel time to walk from address 706 to address 702.

Reference numeral 712 shows respective calculations for different routes 1 through B for bicycling as a mode of transportation, where each calculation is for a travel time to ride a bicycle from address 706 to address 702.

Reference numeral 714 shows respective calculations for different routes 1 through D for using an automobile as a mode of transportations, where each calculation is for a travel time to drive from address 706 to address 702.

Reference numeral 716 shows respective calculations for different routes for other modes of transportations, where each calculation is for a travel time using such other modes to travel from address 706 to address 702 address. Where such other transportation mode data is available, the other modes of transportation can include, but need not be limited to roller blading, roller skating, Segway®, motor driven cycle, row boat, canoe or kayak, water taxi, swimming, jogging, and any combination of any transportation mode that might also be used as a method to calculate travel time from address 706 to address 702.

FIG. 8 illustrates, for a Merchant having a geographic address within one type of a high population density Merchant-Community, navigation algorithm results for each of a plurality of transportation modes for a geographic address associated with an account holder. By way of example, the specific type of high population density might derived from accessible private and/or government data as being a densely populated urban demographic where taxi cabs predominate use of private automobile use and there are a plethora of mass transit options readily available. These accessible private and/or government data can then be used in turn in order to auto-populate predetermined and corresponding Merchant-Community Navigation Time Maximum(s) that can be shown, for instance, at reference numeral 804. In some implementations, the merchant has no obligation to make a contribution to one or more customer selected affinity entities unless the customer's travel time, using at least one of the modes of transportation I though V as seen, respectively, at reference numerals 808-816, is not greater than the maximum(s) at seen at 804. As such, the merchant will incent only those customers who live close by in terms of travel time. Stated otherwise, the merchant's incentive is given only to a customer who is more likely to spend a significant portion of their spending at merchants who have a location that is close to where the customer resides in terms of travel time by any likely mode of transportation that the customer will use to travel to those merchants' locations.

In some implementations, the respective geographic addresses of customer and merchant, whether self-selected or otherwise, when retrieved from one or more network accessible databases, can be compared, using processes, procedures, and methodologies enabled herein, to determine whether the merchant and its customer have the same local community. This comparison ensures that the merchant will incent only those customers who are associated with geographic addresses that are close to that of the merchant's. It is beneficial for the merchant to incent only those customers who are likely to navigate, within a predetermined time, from their pre-set geographic locations (whether these locations are self-selected occupational, recreational, or residential communities, or otherwise) to the merchant's geographic location because those customers are more likely to spend a significant portion of their spending at merchant locations to which those customers can navigate within the predetermined time. Conversely, it may not be beneficial for a merchant to give an incentive to a customer who is associated with a geographic address that is so far away from the merchant's geographic address that will be unlikely that such as customer will spend most of its spending at merchant locations that requires such significant travel times.

Reference numeral 802 shows a geographic address attributed to a merchant. Reference numeral 804 shows a Merchant-Community Identifier that includes a maximum travel time but does not show real time travel conditions weighting, given that automobile traffic driving conditions are an unlikely navigation time factor in the particular type of population density of the Merchant-Community. Reference numeral 806 shows a geographic address attributed to an account holder.

Reference numeral 808 shows respective calculations for different routes 1 through D for using an automobile as a mode of transportations, where each calculation is for a travel time to drive from address 806 to address 802.

Reference numeral 810 shows respective calculations for different routes 1 through M for a mass transit mode of transportation, where each calculation is for a travel time using mass transit as the mode of transportation from address 806 to address 802.

Reference numeral 812 shows respective calculations for different routes 1 through W for walking as a mode of transportations, where each calculation is for a travel time to walk from address 806 to address 802.

Reference numeral 814 shows respective calculations for different routes 1 through B for bicycling as a mode of transportation, where each calculation is for a travel time to ride a bicycle from address 806 to address 802.

Reference numeral 816 shows respective calculations for different routes for other modes of transportations, where each calculation is for a travel time using such other modes to travel from address 806 to address 802 address. Where such other transportation mode data is available, the other modes of transportation can include, but need not be limited to roller blading, roller skating, Segway®, motor driven cycle, row boat, canoe or kayak, water taxi, swimming, jogging, and any combination of any transportation mode that might also be used as a method to calculate travel time from address 806 to address 802.

The present application proposes implementations the purpose of which is to raise funds for affinity entities. An affinity entity can be an organization such as a charity, a non-profit organization, a community social association, a church, etc. Implementations include raising funds for affinity entities by soliciting contributions to the affinity entities from merchants who conduct transactions with account holders. In such implementations, the account holder in the transaction selects one or more affinity entities to whom the merchant's contribution to be contributed. The merchant, however, defines the contribution that is to be made to the affinity entities selected by the account holder. In such implementations, merchants incent such transactions with account holders to raise funds contributed by the merchants to the account holder selected affinity entities.

By way of example, and not by way of limitation, a merchant may define its contributions to be limited so as to promote historically low sales volume types of goods and/or services, for transactions that take place during a historically low or slow sales volume time period. As such, the merchant incents account holders to “lift” and “shift” their purchases into transaction that are targeted by the merchant to promote the merchant's profitability and sales revenue. In the context of retail sales, “lift” refers to the increase in sales that results from a specific marketing or promotional activity. More precisely, it's often referred to as “sales lift.” Sales lift measures the effectiveness of a promotion or marketing campaign by comparing sales during the promotional period to what sales would have been without the promotion (the “baseline” sales). Retailers use sales lift to determine the return on investment (ROI) of their marketing efforts. It allows them to make data-driven decisions about pricing, advertising, and other marketing strategies. When “shift” is used in the context of retail sales and time, it refers to a change or movement in the timing of customer demand or sales activity. By shifting demand, the merchant intends that account holder buying patterns will change, leading to sales occurring at different times of the day, week, month, or year. For example, a retailer might create account holder demand that causes a “shift” in sales from daytime to evening hours, or from weekday to weekend shopping, or to seasonal changes, holidays, or other calendar events that influence consumer behavior. As such the merchant provides incentives to account holders, for instance, that will cause a “shift” in sales toward holiday shopping in December, or a “shift” towards back-to-school shopping in late summer, or a shift to a time period where typically the bulk of when sales happen during a 24 hour period change. An example would be a coffee shop that used to have most of its sales in the morning, but now has most of its sales in the afternoon. Merchant may this define contributions to account holder selected affinity entities so as to optimize staffing, inventory, and marketing efforts such that account holder are most likely to shop so that the merchant attempts to ensure they have the right products and resources available at the right time, and to target the times that account holders are shopping.

To better ensure the success of any fund raising campaign, implementations enabled herein promote such campaigns via advertisements. Content of the advertisements include the promotion of a competition between respective associations of account holders, where each association competes against the other associations in the competition in which the winner will raise more funds in the competition than the other associations for account holder selected affinity entites. To compete, account holders in each association raise funds for affinity entities selected by the account holders by conducting transactions with those merchants who have agreed to make contributions to the affinity entities in exchange for the account holders conduct the transactions with the merchants, where each merchant defines the contribution that is to be made to the one or more account holder selected affinity entities. The fund raising advertisement for the campaign may include the specifics of how funds are raised and how the competition is to be won, including the particulars of how each merchant will define their respective contributions to affinity entities selected by the account holders, how the defined contributions may vary from merchant to merchant, limitations on what transactions, including times and dates, to purchase goods and/or services that may qualify for a merchant contribution to an affinity entity, qualifications for an affinity entity to participate the campaign, secrecy requirements such that the identity of the affinity entity to receive a contribution from a merchant is never disclosed to the merchant although the identity of the affinity entity is both know and selected by the account holder conducing the transaction with the merchant, etc.

Rich transaction data from past transactions with merchants may include one or more Merchant Commodity Codes (MCCs) to designate the type and/or kind of goods and/or services that the merchant sold in the transaction with an account holder. As such, the merchant may define a contribution to an account holder selected affinity entity to be limited to one or more particular Merchant Commodity Code transactions with an account holder.

Given the foregoing, planning and executing a fund raising campaign that is calculated by a vertical AI agent be successful are incorporated into implementations disclosed and enabled herein. The competition identified by the vertical AI agent will preferably make an examination of historical data to best ensure the probably of a successful campaign. This examination may include relevant demographics of for two or more debit/credit associations or groups of account holders that are proposed to compete against each other. This examination may include relevant geotargeted areas in which transactions are to be conducted in the competition that is to take place. This examination may include specified calendar periods for the proposed competition. To best ensure the probably of a successful fund raising campaign, the competition will preferably have a probability that is calculated to exceed a first predetermined threshold to raise funds from merchant defined contributions that exceed a second predetermined threshold. The probability calculations will preferably include historical and current data for geotargeted affinity entities (a.k.a. local charities) selected by the account holders in the geotargeted area, which funds result from account holder transactions with merchants in the geotargeted area, and which transactions are incented by merchant agreements to make defined contributions to the geotargeted, account holder selected affinity entities.

The probability calculations for fund raising campaigned will preferably be performed by a vertical Artificial Intelligence (AI) agent operating on myriad databases to predict demographics for two or more associations or groups of debit/credit account holder in a geotargeted competition during a specified calendar period. The vertical AI agent will preferably identity those competitions that are calculate to have a probability exceeding a first predetermined threshold to raise funds exceeding a second predetermined threshold, which funds are directed to geotargeted charities selected by the account holders in the respective associations or groups, which funds result from account holder transactions with merchants, and which transactions are incented by merchant agreements to make defined contributions to the geotargeted, account holder selected charities.

The myriad databases are preferably network assessable to the vertical AI agent. These databases will preferably include to respective demographics for account holders, past rich transactional data for geotargeted areas under consideration for a competition, past rich transactional data for calendar periods under consideration for competition, current data pertaining to merchant agreements in geotargeted areas to make defined contributions to account holder selected affinity entities charities under consideration for a competition, and other data, past and present, as is need for consideration of any fund raising competition.

Using automatic data analysis, natural language processing, and predictive analytics, the vertical AI agent identifies patterns in demographic, geographic, and transactional databases, to predict competitor groups of account holders most likely to raise statistically significant contributions from merchant defined contributions to account holder selected affinity entities. When the vertical AI agent identifies a fund raising campaign for a competition between associations of account holders, the particulars of the campaign can be advertised.

The advertisement budget for a competition to raise funds by way of a campaign identified by the vertical AI agent will preferably direct ad spending so as to target relevant ad viewing audiences. The probabilities calculated by the vertical AI agent for conducting a successful fund raising campaign will preferably include both advertising spending and the likelihood that such advertising spending on different ad viewers will ensure the likelihood of having a successful fund raising campaign.

The ad spend will preferably be directed, and identified by the vertical AI agent, so as to include one or more advertisements likely to be viewed by those associations of account holders to compete in the fund raising campaign, those merchants with whom the account holders will transaction during the campaign, those affinity entities likely to receive merchant defined contributions during the campaign, each association of account holders to compete in the competition, news outlets in relevant geotarget areas, relevant trade publications, social media influencers, organization of professional solicitors for fund raising such as United Way, fundraising counselors and consultants, development directors, major gifts officers, historically identified high level donors, commercial fundraisers, paid solicitors, etc.

By way of example, and not by way of limitation, the vertical AI agent may be tasked with accessing, retrieving, and analyzing retrieved data from network accessible databases in order to identify those campaigns that have at least a sixty-three percent (63%) probability of raising at least Two Hundred Fifty Thousand Dollars ($250,000.00 US) during the two (2) weeks prior to the Thanksgiving Holiday within the boroughs of New York City and also withing a twenty (20) mile radius thereof, where the identified campaign further predicts and identifies each association or group of account holders to compete against each other in the competition.

By way of example, and not by way of limitation, the vertical AI agent identifies a successful community affinity entity competition by debit/credit account holders employed by either realtors or homebuilders, between November 1st and 15th, for transactions with merchants geographically associated with the greater Cincinnati area, which transactions include, within any twenty-four hour time period, those transactions that are: (i) conducted between 10 AM-3 PM CST, with both a health spa and a restaurant; (ii) conducted after 5 PM CST, with both an entertainment merchant (e.g., theatre, sports, etc.) and a restaurant; (iii) conducted between 10 AM-3:00 PM CST, with a both a clothing store and a restaurant; (iv) conducted prior to 8:15 AM CST with a restaurant; and (v) grouped into at least three (3) different transactions with three (3) different restaurants at which the account holder conducting the transactions had no previous transaction. Note here that the Merchant Commodity Code (MCC) for each merchant may be taken into consideration by the vertical AI agent in identifying the specifics of the proposed fund raising campaign for which the probabilities of a successful campaign are input into the vertical agent as part of its prediction calculations tasks.

In another example, given not by way of limitation, the vertical AI agent identifies a successful community charity competition by account holder transactions with merchants that must include: (i) at least three restaurants in twenty four hour time out; (ii) dining at a restaurant within a time period and immediately followed by an entertainment venue admission purchase (e.g., a movie); (iii) a purchase of clothing and a restaurant purchase within a two and one half hour time period; (iv) a purchase at hardware retailer followed within two hours of a purchase at a ‘big box’ retailer; (v) etc. Note that the vertical AI agent may identify, and use in its prediction algorithms, patterns in past rich transaction data that reveal probable propensities of demographically segmented account holders, each associated with a group thereof to participate in a competition, to conduct transactions for particular good and/or services, with merchant associated with particular Merchant Commodity Codes (MCCs) during certain times-of-day and/or calendar time periods

The task given to the vertical AI agent may include optimizing the fund raising campaign so as to minimizing the advertising spend budget for the campaign while maximizing the probability of the likelihood of the success of the fund raising campaign, and while maximizing the probable amount of funds that are likely to be raised by the campaign.

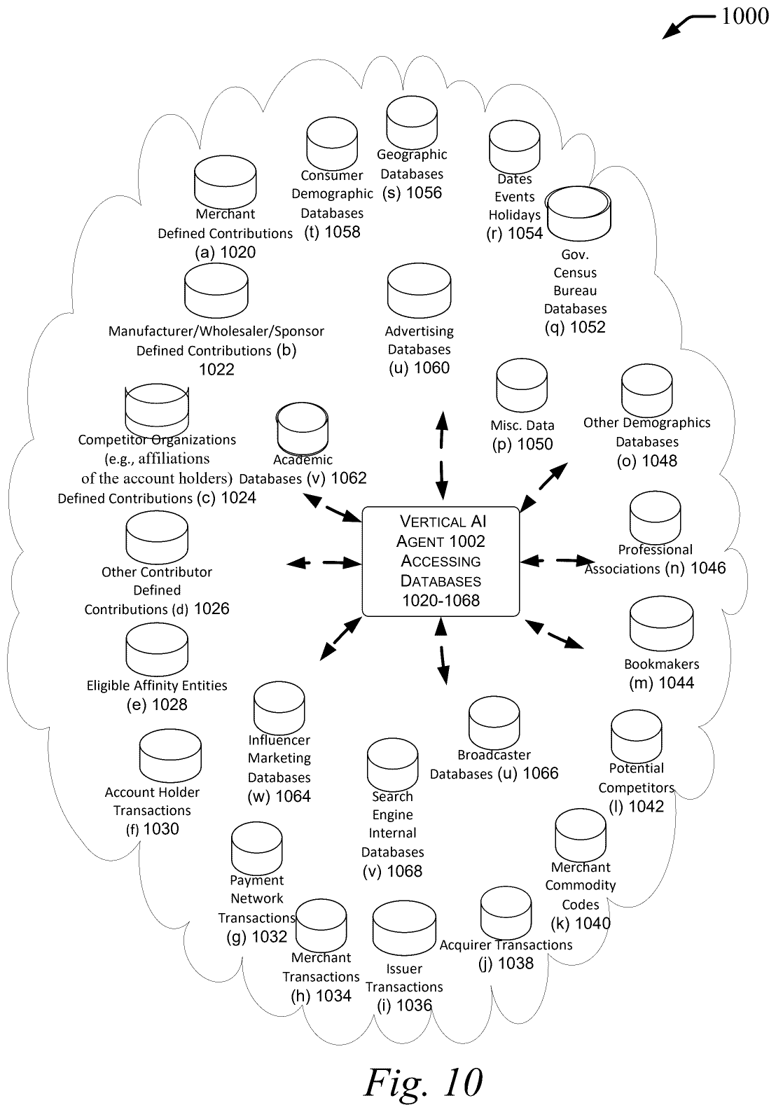

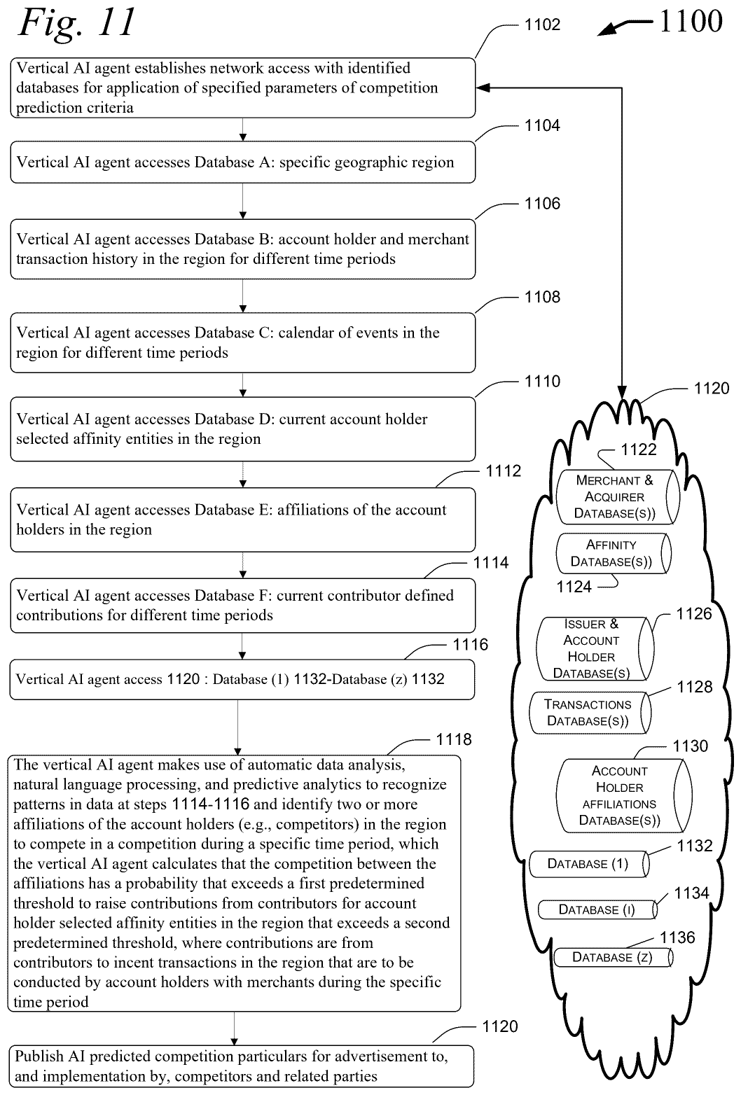

Referring now to FIGS. 9-11, respective flowcharts show processes 900 and 1100, in which a vertical Artificial Intelligence (AI) agent 902 and 1002 operates on myriad databases 906-910 in FIG. 9, 1020-1068 of FIGS. 10, and 1120 in FIG. 11, which databases are accessible to the vertical AI agent 902 and 1002 over networks 904 and 1000 at steps 1102-1120 of process 1100, to retrieve data from respective databases at steps 912-916 of process 1100, and to use at step 919 of process 900 and step 118 of process 1100, prediction algorithms operating on the retrieved data, so as to calculate probabilities and thereby to predict, for a competition between two or more competitor groups of debit/credit account holders, which competition is to take place in a geotargeted area during a specific calendar period, which competition has a probability exceeding a first predetermined threshold to raise funds contributed to account holder selected affinity entities, which contributed funds exceed a second predetermined threshold, which contributed funds are directed to affinity groups (e.g. charities) selected by the account holders, which contributed funds result from account holder transactions with merchants, and which transactions are incented by merchant agreements to make defined contributions to the geotargeted, account holder selected affinity entities.

Step 919 of process 900 and step 118 of process 1100 use automatic data analysis, natural language processing, and predictive analytics in preferred implementation of vertical AI agent 902 and 1002, to identify patterns in the myriad databases 906-910 in FIG. 9, 1020-1068 of FIGS. 10, and 1120 in FIG. 11, to predict those competitor groups that are most likely, as per a first predetermined threshold, to raise statistically significant contributions, as per a second predetermined threshold, from merchant defined contributions to account holder selected charities.

As to the aforementioned prediction algorithms operating on the retrieved data, known techniques can be used such as are used by an advertiser to calculate the odds of the placement of an advertisement for a product resulting in a sale of the product to a customer who viewed the advertisement. While calculating the precise odds of an advertisement leading to a sale can be complex, advertisers typically use various methods and metrics to estimate and improve these odds. Accordingly, implementations for the vertical AI agent for making predictions of likely account holders conducting transaction with merchants in competitions may have respective predetermined parameters, as described in this application. By way of example, and not by way of limitation, these parameters may include various factors and approaches, such as: (i) the number of times an advertisement for a competition of predetermined parameter is displayed; (ii) the percentage of impressions that result in a click (clicks/impressions) in which an account holder for a potential competition is likely to click and receive an impression for the competition and assuming an average degree of how engaging the advertisement of the competition is; (iii) the percentage of clicks that result in a sale or desired action (sales/clicks) that will result in a merchant defined contribution to an account holder selected affinity entity, and assuming average effectiveness of any corresponding landing page and sales process; (iv) determining which touchpoints in the journey of the account holder (e.g., ad clicks, website visits) contributed to the final sale, assuming average input of the ad for the competition as viewed by the account holder; (v) the amount of revenue generated for every dollar spent on advertising the competition to account holders likely to be affiliated with a potential competitor; (vi) the total predicted revenue a merchant can expect from purchases by an account holder; (v) quality, in estimated degree, that the ad for the competition is targeted to the right demographics, interests, and needs of the account holders; (vi) quality, in estimated degree, that the ad for the competition is of suitable quality and relevance of the ad's visuals and messaging; (vii) quality, in estimated degree, as to where the ad for the competition is displayed (e.g., website, social media, search engine results); (vii) quality, in estimated degree, that a landing page for an ad for the competition is relevant, ‘user-friendly’, and persuasive; (viii) quality, in estimated degree, of the ad for the competition as to desirability and competitiveness of the product or service being advertised by the applicable merchants with whom the account holder is likely to conduct a transaction for which the merchant will be obligated to make a contribution to an affinity entity selected by the account holder; (ix) quality, in estimated degree, of economic factors, competition, and seasonal trends; (x) quality, in estimated degree, of different versions of the ad for the competition to predict which might performs best and thereby optimize conversion rates; (xi) quality, in estimated degree, of benefit likely to be gained by the vertical AI agent making use of analytics tools (e.g., Google Analytics, social media analytics, and advertising platform analytics) to track key metrics and identify trends; (xii) quality, in estimated degree, of benefit likely to be gained by the vertical AI agent making use of statistical techniques to analyze historical data and predict future outcomes; and (xiii) quality, in estimated degree, of benefits likely to be gained by the vertical AI agent making use of software to track customer interactions, and automate marketing tasks.

Given the foregoing, both traditional, and future as-yet-to-be developed, implementations may be used by the vertical AI agent, to operate on a myriad of network accessible databases, so as to calculate probabilities and thereby to predict, for a competition between two or more competitor groups of debit/credit account holders to conduct transactions with merchants who have agreement to make contributions to account holder selected affinity entities. By way of example, and not by way of limitation, a myriad of network accessible databases 1020-1068 are seen in FIG. 10 as being in network communication with vertical AI agent 1002. As shown in FIG. 10, a Merchant Defined Contributions Database (a) 120 stores data pertaining to merchant defined contributions to incenting transactions with account holders. Respective definitions for corresponding merchants may include a merchant contribution that is defined to be a percentage of: entire debit/credit transaction, a currency amount of specific goods and/or services in the transaction. The Merchant Contribution may be limited based on: Maximum currency amount of the transaction; Maximum amount of the contribution, Specific Date and/or time of the transaction; Specific goods and/or services in the transaction, Multiple transactions during a specific time period that must be conducted by the account holder; specific goods and/or services purchased in multiple transactions during a specific time period by the account holder; Post-transaction survey(s) that must be completed by account holder.

By way of example, and not by way of limitation, the merchant may define that a contribution will be made by any of the following parameters and/or criteria: (i) transactions, between 10 AM-3 PM CST, with both a health spa and a restaurant, as determined from a Merchant Commodity Code, in the two (2) calendar weeks before Thanksgiving Day, which health spa and restaurant are physically located within a predetermined geographic area; (ii) transactions, after 5 PM CST, with both an entertainment merchant (e.g., theatre, sports, etc.) and a restaurant; (iii) transactions, between 10 AM-3:00 PM CST, with both a clothing store and a restaurant, which transaction are not card-not-present transactions and are conducted in-person by the account holder at respective brick and mortar locations of the clothing store and restaurant; (vi) a transaction, conducted prior to 8:15 AM CST, with a restaurant in a geotargeted area; (v) at least three (3) transactions with restaurants, within a twenty-four (24) time period, with whom the account holder has had no previous transaction; (vi) a transaction that includes at least one (1) product description and/or Stock Keeping Code (SKU) corresponding to at least two (2) specifically identified Manufacturers, Wholesalers, and/or Sponsor Entities (e.g., packaged goods manufactured by General Mills, Inc. and a power tool manufactured by DeWalt, Inc.).

As shown in FIG. 10, a Manufacturer/Wholesaler/Sponsor Defined Contributions (b) 122 stores data similar to pertaining to Merchant Defined Contributions Database (a) 120 in that any of the Manufacturer, Wholesaler, or Sponsor may also make a contribution when an account holder make a corresponding transaction with a merchant, where the transaction includes goods or services associated with the Manufacturer, Wholesaler, or Sponsor. As such, the contribution can be limited as a percentage of: (i) the entire debit/credit transaction; (ii) the currency amount of specific goods and/or services in the transaction; (iii) the Manufacturer/Wholesaler/Sponsor Contribution is Limited based on: (a) the Maximum currency amount of the transaction; (b) the Maximum amount of the contribution (c) the Specific Date and/or time of the transaction; (d) the Specific goods and/or services in the transaction; (e) Multiple transactions during a specific time period; and/or (f) Specific goods and/or services purchased in multiple transactions during a specific time period.

As shown in FIG. 10, a Competitor Organization Defined Contributions (c) 124 stores data similar to pertaining to Merchant Defined Contributions Database (a) 120 in that any Competitor Organization can also make defined contributions to incent transactions with Account Holders who are Members of the Competitor Organization. As such, the contribution can be limited as a percentage of: (i) the Entire debit/credit transaction; (ii) the Currency amount of specific goods and/or services in the transaction; (iii) the Competitor Organization Contribution is Limited based on: (a) the Maximum currency amount of the transaction; (b) the Maximum amount of the contribution; (c) the Specific Date and/or time of the transaction during a time period of a competition; (d) the Specific goods and/or services in the transaction (e) the Multiple transactions during a time period of a competition; and/or (f) the Specific goods and/or services purchased in multiple transactions during a time period of a competition;

As shown in FIG. 10, Other Contributor Defined Contributions (d) 126 database stores data similar to pertaining to Merchant Defined Contributions Database (a) 120 in that any other Contributor also make defined contributions to incent transactions with Account Holders. These Contributors include, but are not limited to, Issuers, Acquirers, Payment Networks (e.g., Visa, Mastercard, American Express, etc.); Account Holders (e.g., who agree to make Matching Contributions to that of other contributor(s)); Manufacturer, Wholesaler, Distributor, Organization Participating In as Competitor in a Competition.

As shown in FIG. 10, Eligible Affinity Entities (e) 128 database stores data similar to pertaining to those affinities that can be selected by Account Holders to receive contributions from contributors due the account holder conducting transaction with merchants. This database (2) 128 designates those affinity entities eligible to receive contributions that incent transactions with merchant, and can include, but are not limited to, entities kept in databases maintained by Governments for nonprofit organizations (e.g., Internal Revenue Service (IRS)); and Charity Databases (e.g., Charity Navigator, GuideStar a.k.a. Candid; CharityWatch, Ministry Watch).

As shown in FIG. 10, various network accessible databases store data pertaining to Past Account Holder/Merchant Debit and/or Credit Transactions. These databases include Account Holder Transactions (f) 130 to store Account Holder Transaction Data, Account number, Account Holder Name, Account Expiration date, Service codes (e.g., CVV codes); Other Magnetic Stripe Data (e.g., sequence numbers). These databases may also store criteria under which an Account Holder will make a contribution to its selected adffinity enity when conducting a transaction. These criteria may include a contribution that is a Percentage of: Entire debit/credit transaction, and/or a Currency amount of specific goods and/or services in the transaction.

As shown in FIG. 10,, a Payment Network Transaction Data (p) 132 database stores past Payment Network Transaction Data, including Transaction Details such as Transaction amount, Merchant identification (Merchant ID)., Merchant Commodity Code (MCC), Date and time of the transaction, Transaction currency, Point-of-sale (POS) data (e.g., online, in-person), account Information, account number, account expiration date, authorization Request and Authorization Response for each transaction; and/or data analytics for issuers, acquirers, merchants, account holders, consumer behavior, data insights.

As shown in FIG. 10, a Merchant Transactions (h) 134 database stores past Merchant Transactions Data, which may include Level 1 Data (Cardholder's account number; Transaction amount, Merchant's identification, Date of the transaction), Level 2 Data (Sales tax amount, Customer code or tax exemption data (if applicable), Merchant Postal Code); and Level 3 Data with transactions (business-to-business (B2B) and business-to-government (B2G)) (Product descriptions and Stock Keeping Codes (SKUs), Quantities, Unit prices, Shipping and tax information, Purchase order numbers); Panel data (Household Panel of purchases over time, Consumer Behavior Insights, Purchase identity, Purchase frequency, Purchase changes and frequency), and/or Point-of-Sale (POS) Data: (products sold, date of sale, sale price).

As shown in FIG. 10, an Issuer Transactions (i) 136 database stores past issuer Transactions Data, which may include past issuer transactions data when a credit or debit card transaction occurs, where the issuer (the bank that issued the credit card to the cardholder) receives specific data to authorize or decline the transaction. Here's what they get and what they do with it. This data may include Cardholder Identification (Card number, Expiration date, CVV (Card Verification Value) or CVC (Card Validation Code); Transaction Details (Transaction amount, Merchant identification (Merchant ID), Multiple Merchant category code (MCCs) for diverse products or services, Date and time of the transaction, Authorization request code, Point of sale data (online, in person, etc.), Authorization Request from the acquirer, passed through the card network, and Authorization Decision).

As shown in FIG. 10, an Acquirer Transactions (j) 138 database stores past acquirer Transactions Data, which may include past Acquirer Transaction Data when a credit card transaction occurs between a merchant and a cardholder. This data may include: Cardholder Information: (Card number, Card expiration date, Card verification value (CVV), Cardholder name); Transaction Information: (Transaction amount, Merchant identification, Date and time of the transaction, Multiple Merchant Commodity (or category) code (MCCs) for diverse products or services, Transaction currency); Point-of-sale (POS) data (e.g., whether the transaction was in-person or online), Authorization Data: (Authorization request and response codes.)

In practice, there are typical processes for receiving transaction Data. The acquirer bank receives the transaction data from the merchant's POS system or payment gateway. Authorization Request: The acquirer forwards the authorization request to the appropriate card network (e.g., Visa, Mastercard) and then to the cardholder's issuing bank. Authorization Response: The acquirer receives the authorization response (approved or declined) from the issuing bank. Transaction Settlement: If the transaction is approved, the acquirer initiates the process of transferring funds from the issuing bank to the merchant's account. Data Security: Acquirer banks are responsible for ensuring the security of transaction data and complying with Payment Card Industry Data Security Standard (PCI DSS) requirements.

As shown in FIG. 10, a Merchant Commodity Codes (k) 140 database stores data pertaining to Merchant Category Codes (MCCs). These are four-digit numbers used to classify businesses by the type of goods or services they provide. By way of example the MCC may identify the merchant to a restaurant, a health spa, a sporting goods retailer, a baker, a movie theatre, a secondatary market retailer of entertainment venue admission ticket, a piano sales retainer, a wholesale food market, a government surplus retailer, a licensor of software and/or database access, an accountant, a law firm, a car wash, a rental agent for a storage facility booths, lockers or garages, a clothing and apparel retailer, etc. The MCC is primarily used by: Credit card companies, Payment processors, and banks. The purposes of the MCC include determining interchange fees (the fees merchants pay to accept credit cards), identifying high-risk merchants, tracking spending patterns, facilitating reward programs (e.g., cash back for specific categories), tax reporting, and otherwise helping financial institutions understand the nature of financial transactions.

As shown in FIG. 10, a Potential Competitors (1) 142 database stores data that the vertical AI agent can use to select potential competitors to compete in the competitions as disclosed herein. This data can pertain to past competitions between identified competitors: Employers, professional societies, social club membership, academic professional and social organizations, community interest groups, musical artists, sports teams, or fans thereof—local, regional, national; event admission ticket sales revenue for the past competitions, sales amounts of branded goods corresponding to the competitors and/or the past competitions, etc. These databases of potential Competitor Organizations can include other data, such as are provided by event data providers (e.g. Sportradar, Opta).

As shown in FIG. 10, a Bookmakers (m) 144 database stores data pertaining to internal wagering systems (e.g., moneylines, point spreads, over/unders, parlays, prop bets, futures), wagerer wagering history; Sports Data Providers, including: Game statistics; Player statistics; Odds data from various bookmakers; Historical sports competition results; data from Odds Comparison Websites (e.g., Odds Shark, VegasInsider, OddsChecker); Gaming Regulatory Bodies (e.g.,: Gaming Commissions), and other such data from betting exchange databases;

As shown in FIG. 10, a Professional Associations (n) 146 stores data pertaining to member data managed via Association Management Software (AMS) (e.g., Association DNA). These data may include Credentialing and Certification Organizations, Certification Bodies (e.g., CompTIA, PMI); Digital Credentialing Platforms storing and manage digital credential; Government and Labor Statistics Databases Medical specialties; American Board of Medical Specialties (ABMS) (e.g. American Osteopathic Association (AOA) (e.g., Internal Medicine, Pediatrics, Surgery, Family Medicine, Cardiology, etc.). The vertical AI agent may calculate probabilities using data in Professional Associations (n) 146 to determine those associations likely be participate in a competition to raise funds for affinity entities selected by account holders in the respective competing associations in a competition identified by the vertical AI agent.

As shown in FIG. 10, an Other Demographics Databases (o) 148, and Misc. Data (p) 150 databases stored other data as needed by the vertical AI agent, which data may pertain to Demographics Data: (Business—Industrial, Residential, Professional Society and Associations, Trade Unions, and as other miscellaneous data.

As shown in FIG. 10, a Government Census Bureau Databases (q) 152 stores data pertaining to age, gender, income, education, and household information from various Government Sources (e.g., U.S. Bureau of Labor Statistics (BLS)); U.S. Census Bureau; Statistics of U.S. Businesses (SUSB) program; Employment; payroll by geographic area; Private Sector Databases (e.g., People Data Labs; Local Chambers of Commerce; Local Economic Development Agencies; Local Business Publications); Academic and Data Science Competitions (e.g., Kaggle for data science competitions; DrivenData for data science competitions with a social impact on public health, environment, conservation); Conflict and Political Competitions (e.g., Uppsala Conflict Data Program (UCDP) for competing groups); Election databases; Social Science Databases (e.g., World Values Survey, International Social Survey Programme for social and political attitudes used to analyze competition between different groups within societies.); Business Competitions (e.g., databases for market share and competitive landscapes to analyze competition between businesses); and Financial Databases to analyze business competitive performance.

As shown in FIG. 10, a Dates Events Holidays (r) 154 database stores data pertaining to World Wide Websites for Dates, calendar events, holidays; Time and Date (e.g., timeanddate.com); worldwide public holidays database (e.g., qppstudio); Cultural holidays, observances, special days (National Today e.g., nationaltoday.com); National Day Calendar (e.g., nationaldaycalendar.com). The vertical AI agent may use data from Dates Events Holidays (r) 154 database to determine dates for a competitions determined to be likely to raise significant contributions from contributors for transactions conducted by account holders with merchants.

As shown in FIG. 10, a Geographic Databases(s) 156 database stores data pertaining to Geographic Data, such as Postal Code, County, City, Borough, Community and groupings thereof, State, Province, governmental procession; Geographic areas corresponding to specific telephone area codes; Telephone Area Code geographic associations; Tribal Nation, First Peoples Land-Territory; Military Bases and installations; Territories of the USA and other countries; districts of a countries.

As shown in FIG. 10, a Consumer Demographic Databases (t) 158 stores data pertaining to Consumer Demographic Data: Consumer Psychographics, Values, Interests, Opinions, Lifestyles, Attitudes, Personality traits, Age, gender, income, education, location, lifestyle, consumer behavior, product usage, consumer demographics and segmentation, lifestyle segmentation data grouping consumers into distinct clusters, Market Research and Industry Data: (market trends, industry analysis, competitor data, consumer markets, consumer trends, industry specific statistics, market specific statistics); Demographic and Consumer Data: (Account Holder Data, Magnetic Stripe Data, age, gender, income, education, location, lifestyle, consumer behavior, product usage, consumer demographics and segmentation, lifestyle segmentation data, grouping consumers into distinct clusters, and media consumption).

As shown in FIG. 10, Advertising Databases (u) 160 store data pertaining to advertising spending across various media, advertising rates and advertising market analysis, advertiser agency relationships, Business Databases: (private and public business data, industry news, executive contact information, industry profiles; Market Research and Industry Data: (market trends, industry analysis, competitor data, consumer markets, consumer trends, industry specific statistics, market specific statistics).

As shown in FIG. 10, Academic Databases (v) 162 store data pertaining to Academic Databases, academic journals and publications, and Industry specific peer-reviewed business publications.

As shown in FIG. 10, Influencer Marketing Databases (w) 164 store data pertaining to social media influencers from various Social Media Platforms: Facebook, Instagram, X, YouTube, Instagram, TikTok, LinkedIn, Snapchat, Pinterest, etc.). These data may also include influencer audience demographics such as engagement rates, content, influencers specific interest and fan communities, audience demographic information, Age, Location, Followers (interests, spending habits, Purchasing behavior, Social media activity, Event attendance, Social listening tools within specific fan communities (Interest-based targeting, Keyword targeting, Hashtag targeting, and ‘Lookalike’ audiences).

As shown in FIG. 10, Broadcaster Databases (u) 166 store data pertaining to Title, description, and keywords for broadcast media, program schedules, Air dates and times, Audience and Ratings Databases: (Demographic information of viewers/listeners, and Viewing/listening habits).

As shown in FIG. 10, Search Engine Internal Databases (v) 168 store data pertaining Keyword Research Tools (e.g., Google Keyword Planner, Ahrefs, SEMrush, Moz, Google Trends), and Academic and Research Databases (e.g., anonymized search query data);

Referring now to FIG. 12, a flow diagram shows steps 1202, 1204, 12012, and 1208. Steps 1202-1208 are illustrated to show different methods of contribution generation.

At step 1202, a Merchant-funded contribution is seen in the upper box of step 1202, where shopping at local participating businesses generates a merchant-defined micro-contribution to the non-profit organizations participating in the platform. (e.g. Bob's Shoe Store contributes 2% on each member purchase). As shown in the lower box of step 1202, a Card Loyalty contribution is illustrated via using a credit of debit card affiliated with the platform can generate contribution to the local non-profit organizations participating in the platform. (e.g. the ABC Bank credit card generates one percent (1%) contribution with every purchase).

At step 1204 and step 1206, Consumer Directed Contribution Allocations are illustrated. At step 1204, Consumer Non-profit Preference are shown where, regardless of the method of contribution generation, the consumer can direct the contributions to their preferred local non-profits in the ratio they select (i.e. 30% for non-profit #1, and 70% to non-profit #2).

At step 12012, a Contribution Type Preference is set such that, within the preference selection for each non-profit, the contribution type allocation can be a blend of the following: (i) Standard Contribution Type, with a standard contribution, non-profits are provided the funds to use as they deem appropriate (un-restricted); for example: the money contributed can be used now to support the local community; and (ii) Endowment Contribution, with endowment contributions, the Contribution Management Program provides non-profits with an endowment fund through a bank-offered wealth-management account (“DMP Account”). The contributions help build the balance of the account and the interest and gains from the account can then be used as an ongoing/consistent revenue source. For example: the money provided is invested and the dividends of that investment can be used as future revenue. This may have the added benefit of supporting financial management with the non-profit. Additionally, the endowment can be used as collateral for a line of credit for the non-profit.

At step 1208, a Contribution Deposit is shown. Once the consumer directed contribution allocations are calculated, the appropriate amounts are deposited into the identified accounts.

Note that the flow chart seen in FIG. 12 can represent the flow of contributions through an engine that can be audited by a certified audit firm to ensure that the core principles of the platform are adhered to, such as are common for trust funds, endowment funds, and the like.

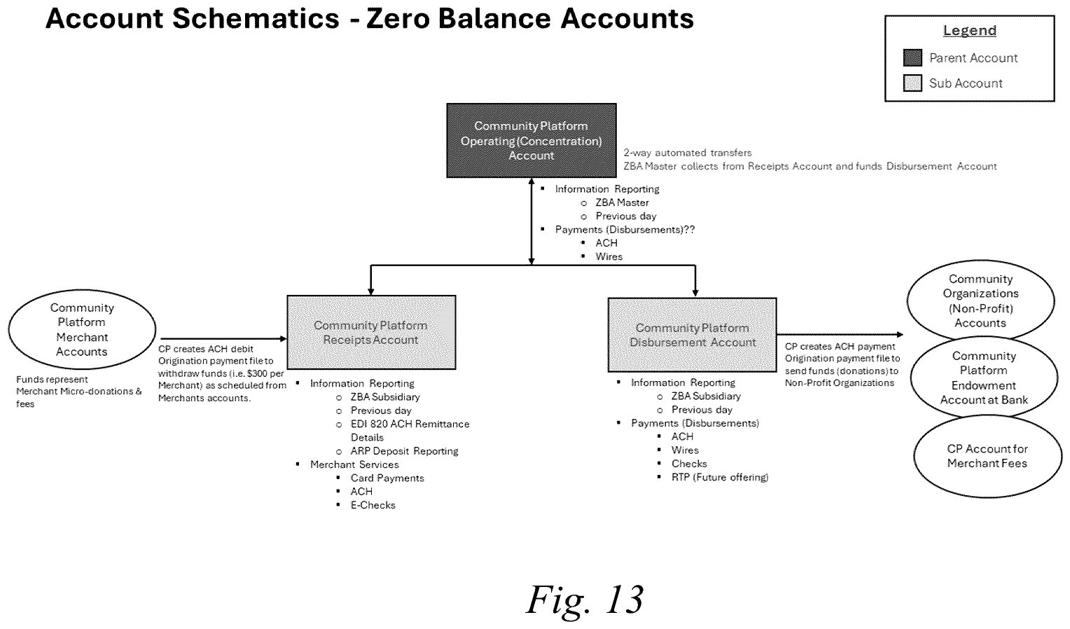

Referring now to FIG. 13, there is illustrated an account schematic diagram depicting one example of a zero balance implementation of merchant accounts and an operating account. The merchant accounts make contributions to receipt accounts after an incented transaction has been conducted the merchant with an account holder (e.g., a consumer). The operating account distributes funds between the receipt accounts and a disbursement account.

A Community Platform Operating (Concentration Account) is seen in FIG. 13, to facilitate 2-way automated transfers where a ZBA Master collects from Receipts Account and funds Disbursement Account. Thereafter, information reporting is made on the ZBA Master from the previous day as to payments or disbursements via Automated Clearing House (ACH) and/or wires.

Community Platform Merchant Accounts are seen in FIG. 13 to contain funds representing Merchant Micro-contributions and fees. The Community Platform (CP) creates a ACH debit origination payment file to withdraw funds (i.e. $300 per Merchant) as scheduled from Merchants accounts.

A Community Platform Receipts Account is shown in FIG. 13, with information reporting that includes: (i) ZBA Subsidiary; (ii) Previous day; (iii) EDI 820 ACH Remittance; (iv) Details; and (v) ARP Deposit Reporting. The Community Platform Receipts Account shown in FIG. 13 also includes these Merchant Services: (i) Card Payments; (ii) ACH; and (iii) E-Checks.

A Community Platform Disbursement Account is shown in FIG. 13, with information reporting that includes: (i) ZBA Subsidiary; (ii) Previous; and Payments or Disbursements that include ACH, wires, checks and real time payments. CP creates an ACH payment Origination payment file to send funds (contributions) to various charity (Non-Profit Organizations).

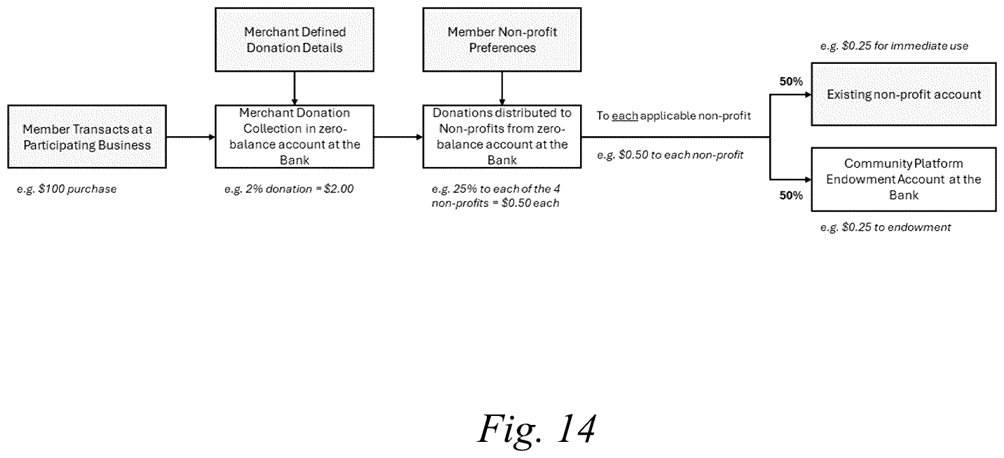

Referring now to FIG. 14, there is illustrated a flowchart depicting a method for establishing the operation of the Community Platform Endowment. By way of an overview of FIG. 14, micro-contributions, through the Community Platform philanthropic marketing SaaS platform, are generated on behalf of the merchant, and directed by the consumer's choice to the non-profits, delivered as a non-taxable gift, including the endowment portion. As part of their participation in the Community Platform, non-profit partners are included in the Community Platform Endowment.

Conceptually, the method shown in FIG. 14 allows consumers to select from participating community organizations to direct their contributions from merchants with whom transactions are conducted. These transactions are conducted at participating businesses that are easily enrolled in the Community Platform via auto-boarding processes. Thereafter, the participating merchants contribute a merchant-defined percentage of each transaction. The Community Platform matches each purchase to the transacting consumer and facilitates the contribution with a professional auditor. Consumers shop at participating businesses, using an account issued by an issuer (e.g., a debit and/or credit card), to make a purchase which then generates a contribution at no additional cost to the consumer. After completing a purchase, consumers are able to provide the merchant with anonymous, valuable e-feedback in real-time to the merchant with whom the transaction was conducted.

By way of example, and not by way of limitation, the real-time e-feedback from the consumer to the merchant can be facilitated, for each transaction conducted by the merchant with the consumer, by sending a survey pertaining to the transaction to a logical address network location corresponding to the consumer and by receiving, in response to the survey, a survey response pertaining to the transaction from the logical address network location corresponding to the account holder. Thereafter, for each said survey response pertaining to the transaction, a portion of the survey response pertaining to the transaction can be sent to a logical address network location corresponding to the merchant.

In the exemplary method shown in FIG. 14, an CP Member transacts at a participating business (e.g., a purchase of $100 is made from a merchant). The merchant has defined what contribution will be made for different transactions with consumers. The merchant contribution is collected in a zero balance account at a bank (e.g., “National Bank”). By way of example, the contribution is two percent of the amount of the transaction or two dollars. Thereafter, contributions are distributed to Non-profits from the zero balance account at the bank according to the CP member's selection of a particular non-profit organization. (e.g., 25% to each of the non-profits=$0.50 each). To each applicable non-profit there is distributed, for instance, $0.50 to each non-profit organization. The contribution is spit in two with half being deposited into an account for the selected non-profit organization and the other half being deposited into an endowment at the bank that is held in trust for the non-profit organization in an endowment fund.

Intended objectives of the exemplary method shown in FIG. 14, include conveying and enabling benefits to the bank by: (i) Diversified Revenue Streams, where the Community Platform Endowment provides additional revenue streams beyond traditional banking products, contributing to a diversified income base for the bank; (ii) Value to the bank, where there are enhanced customer relationships built by deeper, more long-term relationships with new non-profit clients, increasing customer engagement, loyalty and retention; (iii) Brand Differentiation by offering the Community Platform Endowment sets the bank apart from competitors and enhances brand reputation; (iv) Access to high-net-worth individuals by cross-selling opportunities with top individual spenders on the Community Platform; and (v) Long-Term Assets Under Management (AUM): The Community Platform Endowment helps accumulate long-term assets under management, leading to sustained profitability and growth for the bank.

Intended objectives of the exemplary method shown in FIG. 14, include conveying and enabling benefits to non-profit organizations selected by customers to receive merchant bifurcated contributions by: (i) Financial Stability: The Community Platform Endowment provides a stable and reliable source of funding for the non-profit, supporting its financial sustainability over the long term while offering flexibility in funding, allowing the nonprofit to allocate resources to areas of greatest need or to seize new opportunities for innovation and growth; (ii) Stability in Uncertain Times: Unencumbered funds from the endowment enable the non-profit to continue pursuing its mission and serving the community, even during times of economic uncertainty or fluctuations in contributor support; (iii) Expand Impact in Community: With consistent funding from the Community Platform Endowment, a non-profit can expand programs and services to reach more individuals and allows addressing a wider range of community needs; (iv) Legacy Building: The Community Platform Endowment can serve as a lasting legacy for the Community Platform members, ensuring that their contributions continue to make a positive impact on the community for generations to come; and (v) Asset Utilization: The principal of the Community Platform Endowment can be used by non-profits as collateral for additional bank funding (e.g. an operating line of credit).

TABLE A, below, three examples for operation of the Community Platform:

| Category | Example 1 | Example 2 | Example 3 |
|---|---|---|---|
| Average endowment | $1,000,000 | $5,000,000 | $10,000,000 |
| balance at the bank | | | |
| Number of Non-profits with | 1,000 | 1,000 | 1,000 |
| endowments at the bank | | | |
| Total Value of endowments | $1,000,000,000 | $5,000,000,000 | $10,000,000,000 |
| at the bank | | | |
| Annual rate of growth | 5% | 5% | 5% |
| (Conservative) | | | |
| Total value generated | $50,000,000 | $250,000,000 | $500,000,000 |
| for the non- profits | | | |
| annually | | | |

In other implementations of the method shown in FIG. 14, matching opportunities are facilitated were the Community Platform contribution matching is offered to members who opt to match merchant-defined micro-contributions on their Community Platform co-branded card (or other payment cards) and receive a tax receipt for their contribution to the Community Platform non-profits. Also, there can be a facilitation of other contributions, where Community Platform members and bank clients can opt to direct their personal funds to the Community Platform Endowments of non-profits in their community.

In yet other implementations to that of FIGS. 12-14, of a merchant having an out-of-state physical location in a first state may make a contribution to a foundation designed for an account holder who conducted a transaction with the merchant, where the account holder as a physical location in different, second state. As such the out-of-state merchant's contribution will be directed to the account holder's in-state foundation. Accordingly, a micro-targeted-instate contribution has been made by an out-of-state merchant.

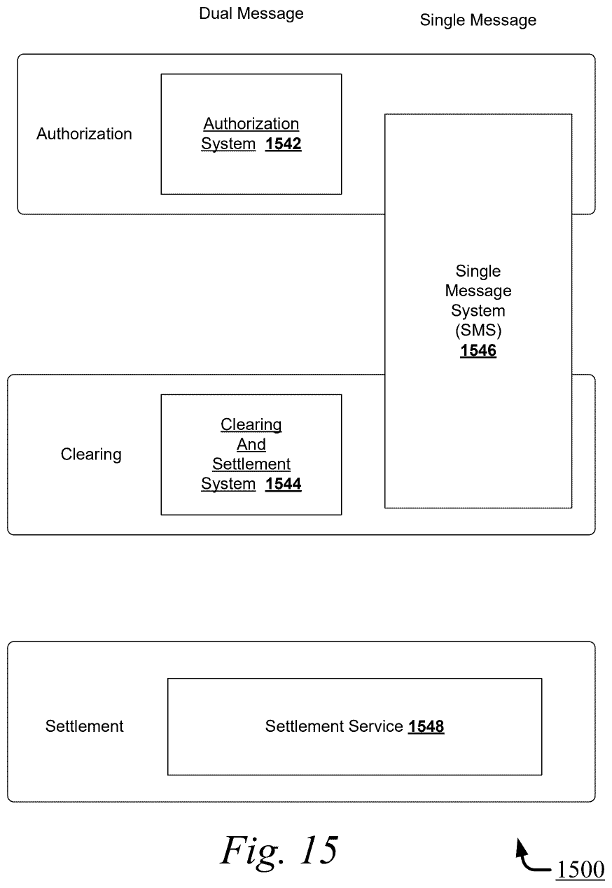

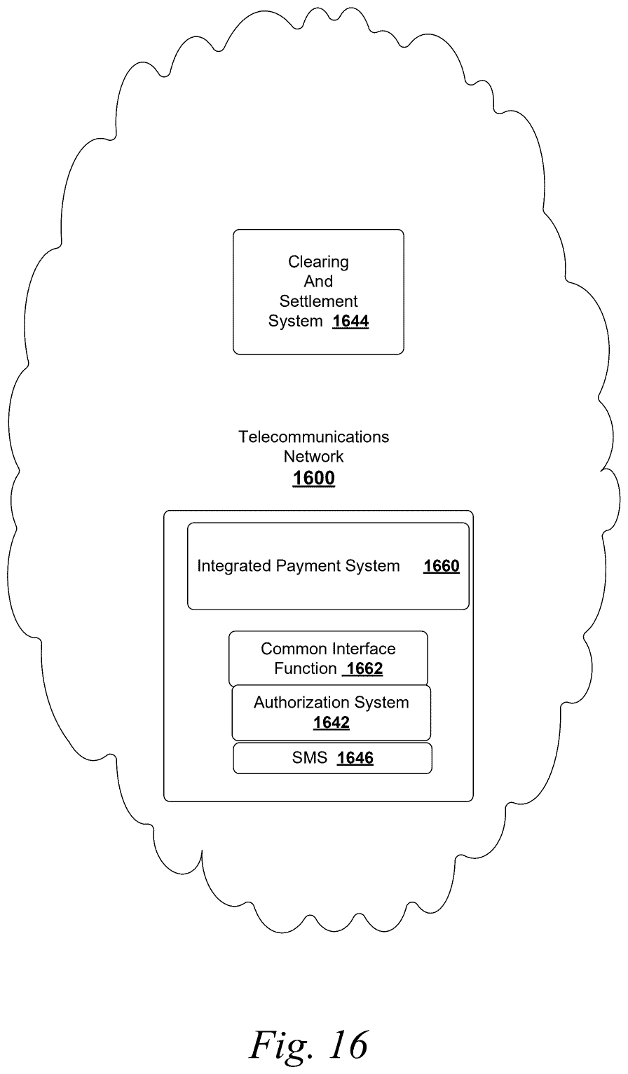

Referring now to FIGS. 15-16, with further reference to FIGS. 1-2 and 6, access points 230, 232 seen in FIG. 2 are shown in network communication with Transaction Handler 202 and each Acquirer (i) 206 and Issuer (j) 204. Other entities such as drawee banks and third party authorizing agents may also connect to the financial; network through an access point (not shown). An interchange center has systems, such as those seen at reference numeral 1540 see in FIG. 15, so as to be a data processing center that may be located anywhere in the world. Each interchange center houses the computer system that performs the network transaction processing. The interchange center serves as the control point for the telecommunication facilities of the network, which comprises high-speed leased lines or satellite connections, for instance as may be based on IBM SNA protocol. Preferably, the communication lines that connect an interchange center (Transaction Handler 202) to remote entities use dedicated high-bandwidth telephone circuits or satellite connections, for instance as may be based on the IBM SNA-LUO communication protocol. Messages are sent over these lines using any suitable implementation of the ISO 8583 standard.

Access points 230, 232 seen in FIG. 2 are typically made up of small computer systems located at a processing center that interfaces between the center's host computer and the interchange center system 1540 seen in FIG. 15. The access point facilitates the transmission of messages and files between the host and the interchange center supporting the authorization, clearing and settlement of transaction. Telecommunication links between the Acquirer (i) 206 and its access point 232, and between the access point 230 and Issuer (j) 204 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. In addition, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

FIG. 15 illustrates Interchange Center systems 1540 housed within an interchange center to provide on-line and off-line transaction processing. For dual message transaction, authorization system 1542 provides authorization. Authorization system 1542 supports on-line and off-line functions, and its file includes internal systems tables, a customer database and a merchant central file. The on-line functions of system 1542 support dual message authorization processing. This processing involves routing, account holder and card verification and stand-in processing, and other functions such as file maintenance. Reporting includes authorization reports, exception file and advice file reports, POS reports and billing reports. A bridge from system 1542 to a Single Message System (SMS) 1546 makes it possible for issuers and acquirers to use system 1542 to communicate with other issuers and acquirers using system 946 and access the SMS gateways to outside networks.

Clearing and settlement system 1544 clears and settles previously authorized dual message transactions. System 1544 collects financial and non-financial information and distributes reports between members. It also calculates fees, charges and settlement totals and produces reports to help with reconciliation. A bridge forms an interchange between system 944 processing centers and system 1548 processing centers.

Single message system 1546 processes full financial transactions and can also process dual message authorization and clearing transactions, as well as communicate with system 942 using a bridge and to access outside networks as required. System 1546 processes cashless issued account-based acquired transactions, for instance Visa, Plus, Interlink. Maestro, Cirrus, and others. By way of example, SMS files comprise internal system tables that control system access and processing, and an account holder database, which contains files of account holder data used for Personal IDentifier (PIN) verification and stand-in processing authorization. System 1546 has on-line functions that perform real-time account holder transaction processing and exception processing for authorization as well as full financial transactions. System 946 also accumulates reconciliation and settlement totals. System 1546 also has off-line functions that process settlement and funds transfer requests and provide settlement and activities reporting. Settlement service 1548 consolidates the settlement functions of system 1544 and 1546 for cashless issued account-based acquired transactions into a single service for all products and services. Clearing continues to be performed separately by system 1544 and system 1546.

FIG. 16 illustrates another view of components of FIG. 15 in a telecommunications network 1600. Integrated payment system 1660 is the primary system for processing all on-line authorization and financial request transactions. System 1660 reports both dual message and single message processing. In both cases, settlement occurs separately. The three main software components are the common interface function 1662, authorization system 1642 and single message system 1646.

Common interface function 1662 determines the processing required for each message received at an interchange center. It chooses the appropriate routing, based on the source of the message (system 1642, 1644 or 1646), the type of processing request and the processing network. This component performs initial message editing, and, when necessary, parses the message and ensures that the content complies with basic message construction rules. Common interface function 1062 routes messages to their system 1642 or system 1646 destinations.

Referring again now to FIGS. 1-2, FIG. 6, and FIGS. 15-16, further illustrations are seen of a telecommunications network, including but not limited to a telecommunications network that utilizes a constellation of low Earth orbit (LEO) satellites, a.k.a, a LEO satellite constellation or a LEO satellite network, where such networks consist of numerous satellites orbiting relatively close to Earth, which allows for lower latency compared to traditional geostationary satellites. The telecommunications network may make use of any suitable telecommunications network and may involve different hardware, different software and/or different protocols then those discussed below. FIGS. 1-2, FIG. 6, and FIGS. 15-16 can include a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments. These transactions are processed through the network's authorization, clearing and settlement services. Authorization occurs when an issuer approves or declines a sales transaction before a purchase is finalized or cash is dispersed. Clearing occurs when a transaction is delivered from an acquirer to an issuer for posting to the customer's account. Settlement is the process of calculating and determining the net financial position of each member for all transactions that are cleared. The actual exchange of funds is a separate process.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions. Moreover, a non-transient computer readable medium can include such software as instructions executed by hardware to perform steps of methods described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. A method comprising a plurality of steps each being performed by hardware executing software, wherein the steps include:
receiving information derived from an authorization response for a transaction with a merchant conducted on an account issued to an account holder on an account, wherein the information includes:
the date and time of the transaction;
a currency amount of the transaction; and
identifiers for the merchant and the account holder;
accessing one or more databases:
using the identifiers for the merchant and the account holder to look-up information corresponding to the respective communities of the account holder and the merchant;
using the identifier for the merchant to look-up information corresponding to:
a business rule by which the merchant will make a contribution to an affinity entity using the identifier for the merchant;
the logical address of the merchant using the identifier for the merchant;
and
using the identifier for the account holder to look-up information corresponding to an identifier of the affinity entity;
for each said transaction for which the respective communities of the account holder and the merchant match:
deriving, using the business rule, the contribution to be made by the merchant to the affinity entity; and
transmitting a message to a logical address containing the contribution to be made by the merchant to the affinity entity;
deriving, using predetermined contribution rules, information characterizing the contribution to be made by the merchant to the affinity entity as being bifurcated into:
a fund to which the affinity entity has ready access;
and
an endowment trust for the benefit of the affinity entity to which the affinity entity has access to a portion of income from investment of the principal in the endowment trust;
and
for each said transaction conducted by one said account holder with one said merchant, for each group for which the one said account holder has a membership designed by a globally unique identifier, where each said group is participating in a challenge against at least one other said group to make contributions matching that of said merchants to said affinity entities, recording an obligation of the group in which the one said account holder has membership to make a matching contribution to that made by the one said merchant for each corresponding said transaction conducted by the one said account holder with the one said merchant.

2. The method as defined in claim 1, wherein the steps further comprise, a predetermined time period after the date of the transaction:
receiving a plurality of contribution receipts each including:
the respective identifiers for the merchant and the affinity entity; and
a currency amount;
deriving the sum of the currency amounts of the contribution receipts for the affinity entity;
determining a difference between:
the sum of the currency amounts of the contribution receipts that were transmitted to the logical address of the merchant for the affinity entity; and
the sum of the currency amounts of the contribution receipts that were received for the affinity entity for the merchant;
and
transmitting the determined difference to a logical address.

3. The method as defined in claim 2, wherein the logical address to which the message and the determined difference are transmitted is selected from the group consisting of:
a logical address for the merchant;
a logical address for the account holder;
a logical address of the affinity entity; and
a combination thereof.

4. The method as defined in claim 1, wherein:
each said transaction occurs in a system that includes a plurality of said merchants each conducting transaction on a respective said account issued to a respective said account holder by a respective issuer;
each said transaction on each said account is acquired for clearing and settlement by an acquirer for each said merchant through a transaction handler in communication with both the issuer of the account and the acquirer for the merchant; and
the issuer sends a corresponding said authorization response for the transaction to the merchant through the transaction handler and the acquirer in response to an authorization request sent to the issuer from the merchant through the transaction handler and the acquirer.

5. The method as defined in claim 1, wherein the steps further comprise using the information corresponding to the respective communities of the account holder and the merchant to derive whether the respective communities of the account holder and the merchant match.

6. The method as defined in claim 1, wherein:
the derivation of the match is performed by using the information corresponding to the respective communities of the account holder and the merchant to determine that the account holder and the merchant have the same community;
and
the same community is selected from the group consisting of the same province, the same state, the same county in the same state, the same prefecture, the same city in the same state, the same city-state, the same borough in the same city, the same postal code for the delivery of posted mail, and combinations thereof.

7. The method as defined in claim 1, wherein:
the information corresponding to the respective communities of the account holder and the merchant includes respective geographic locations for the account holder and the merchant;
the derivation of the match is performed by using a navigation algorithm and the respective geographic locations for the account holder and the merchant;
the navigation algorithm computes a navigation time between from the respective geographic locations for the account holder and the merchant; and
the navigation time is computed to be below a predetermined maximum in order for the respective communities of the account holder and the merchant to match;0
and
the navigation time is computed for a transportation mode selected from the group consisting of walking, automobile, bicycle, mass transit, and a combination thereof.

8. The method as defined in claim 1, wherein the steps further comprise retrieving, using at least one of the respective merchant, account holder, and affinity entity identifiers, a logical address selected from the group consisting of:
the logical address of the merchant;
the logical address of the account holder;
the logical address of the affinity entity; and
a combination thereof.

9. The method as defined in claim 2, wherein the derivation of the contribution to be made by the merchant to the affinity entity for the predetermined time period using the respective account holder and merchant contribution business rules is a function, at least in part, of the received currency amount.

10. The method as defined in claim 1, wherein the steps further comprise, for each transaction conducted by the merchant on the account issued to the account holder:
sending a survey pertaining to the transaction to a logical address network location corresponding to the account holder; and
receiving, in response to the survey, a survey response pertaining to the transaction from the logical address network location corresponding to the account holder.

11. The method as defined in claim 10, wherein the steps further comprise, for each said survey response pertaining to the transaction, sending at least a portion of the survey response pertaining to the transaction to a logical address network location corresponding to the merchant.

12. A non-transient computer readable medium comprising software executed by hardware to perform the steps of the method as defined in claim 1.

13. A method comprising a plurality of steps each being performed by hardware executing software, wherein the steps include:
receiving information derived from an authorization response for a transaction with a merchant conducted on an account issued to an account holder, wherein the information includes:
the date and time of the transaction;
a currency amount of the transaction; and
identifiers for the merchant and the account holder;
accessing one or more databases:
using the identifiers for the merchant and the account holder to look-up information corresponding to the respective communities of the account holder and the merchant;
using the identifier for the merchant to look-up information corresponding to:
a business rule by which the merchant will make a contribution to an affinity entity using the identifier for the merchant;
the logical address of the merchant using the identifier for the merchant;
and
using the identifier for the account holder to look-up information corresponding to an identifier of the affinity entity;
for each said transaction for which the respective communities of the account holder and the merchant match:
deriving, using the business rule, the contribution to be made by the merchant to the affinity entity; and
transmitting a message to a logical address containing the contribution to be made by the merchant to the affinity entity;
and
deriving, using predetermined contribution rules, information characterizing the contribution to be made by the merchant to the affinity entity as being bifurcated into:
a fund to which the affinity entity has ready access;
and
an endowment trust for the benefit of the affinity entity to which the affinity entity has access to a portion of income from investment of the principal in the endowment trust.

14. The method as defined in claim 13, wherein the steps further comprise, a predetermined time period after the date of the transaction:
receiving a plurality of contribution receipts each including:
the respective identifiers for the merchant and the affinity entity; and
a currency amount;
deriving the sum of the currency amounts of the contribution receipts for the affinity entity;
determining a difference between:
the sum of the currency amounts of the contribution receipts that were transmitted to the logical address of the merchant for the affinity entity; and
the sum of the currency amounts of the contribution receipts that were received for the affinity entity for the merchant;
and
transmitting the determined difference to a logical address.

15. The method as defined in claim 14, wherein the logical address to which the message and the determined difference are transmitted is selected from the group consisting of:
a logical address for the merchant;
a logical address for the account holder;
a logical address of the affinity entity; and
a combination thereof.

16. The method as defined in claim 13, wherein:
each said transaction occurs in a system that includes a plurality of said merchants each conducting transaction on a respective said account issued to a respective said account holder by a respective issuer;
each said transaction on each said account is acquired for clearing and settlement by an acquirer for each said merchant through a transaction handler in communication with both the issuer of the account and the acquirer for the merchant; and
the issuer sends a corresponding said authorization response for the transaction to the merchant through the transaction handler and the acquirer in response to an authorization request sent to the issuer from the merchant through the transaction handler and the acquirer.

17. A non-transient computer readable medium comprising software executed by hardware to perform the steps of the method as defined in claim 13.

18. A method comprising:
accessing and retrieving data, by a vertical artificial agent, from network accessible databases;
and
operating, with the vertical artificial agent, on the retrieved data to predict, for a competition between two or more competitor groups of account holders, wherein the competition:
is to take place in a geotargeted area during a specific calendar period;
and
has a probability exceeding a first predetermined threshold to raise funds contributed to account holder selected affinity entities, wherein the contributions:
exceed a second predetermined threshold;
are directed to affinity groups selected by the account holders;
result from account holder transactions with merchants in which the transactions are incented by merchant agreements to make the contributions to the geotargeted, account holder selected affinity entities.

19. The method as defined in claim 18, wherein the vertical artificial agent uses at least one of automatic data analysis, natural language processing, and predictive analytics to identify patterns in the retrieved data to predict those competitor groups that are most likely, by the first predetermined threshold, to raise statistically significant contributions, by the second predetermined threshold, from merchant defined contributions to account holder selected charities.

20. A non-transient computer readable medium comprising software executed by the vertical artificial agent to perform the steps of the method as defined in claim 18.
